(19) United States
(12) Patent Application Publication
(10) Pub. No.: US 2018/0184759 A1
(43) Pub. Date: Jul. 5, 2018

(54) Non-slip Removable Footwear Insert

(71) Applicant: James Paul Chemeski, Glen Burnie, MD (US)

(72) Inventor: James Paul Cherneski, Glen Bernie, MD (US)

(21) Appl. No.: 15/120,129

(22) PCT Filed: Dec. 23, 2015
(86) PCT No.: PCT/IB2015/002412

§ 371 Date: Aug. 19, 2016

Related U.S. Application Data
(60) Provisional application No. 62/095,786, filed on Dec. 23, 2014.

(51) Int. Cl. A43B 17/18; A43B 1/00; A43B 1/04; A43B 17/00; A43B 17/08; A43B 17/14; A43B 19/00; A43B 5/00; B32B 3/26; D04B 1/16; D04B 1/24; D04B 21/20; B32B 5/02; B32B 1/00

(52) U.S. Cl. CPC A43B 17/18; A43B 13/223; A43B 1/04; A43B 17/003; A43B 17/08; A43B 17/14; A43B 19/00; A43B 5/00; B32B 3/266; D04B 1/16; D04B 1/24; D04B 21/207; B32B 5/026; B32B 1/00; A43B 1/0081

(57) ABSTRACT

A non-slip removable footwear insert includes an insert member and a non-slip material applied on an upper surface and a lower surface of the insert member. The insert member conforms to and is removably positioned on an inner surface of footwear. The upper surface of the insert member is proximal to a user contact surface, for example, a bottom surface of a user's foot, and distal to the inner surface of the footwear. The lower surface of the insert member is proximal to the inner surface of the footwear and distal to the user contact surface. The non-slip material applied on the upper surface and the lower surface of the insert member provides simultaneous gripping contact between the upper surface of the insert member and the user contact surface, and between the lower surface of the insert member and the inner surface of the footwear.

### CROSS-REFERENCE TO RELATED APPLICATIONS

This application is a national stage application of PCT international application number PCT/IB2015/002412 titled “NON-SLIP REMOVABLE FOOTWEAR INSERT”, filed on Dec. 23, 2015, which claims priority to and the benefit of provisional patent application No. 62/095,786 titled “Removable Non-slip Insert For Footwear”, filed in the United States Patent and Trademark Office on Dec. 23, 2014. The specifications of the above referenced patent applications are incorporated herein by reference in their entirety.

### BACKGROUND

Shoe inserts are inserted into shoes to provide comfort to a user's feet inside the shoes. A shoe insert positioned over an inner surface of a shoe, for example, over an insole of the shoe provides cushioning to an underside of the user's foot that is inserted into a cavity of the shoe. Conventionally, shoe inserts are made using hard plastic materials or soft materials, for example, cloth, gel, foam, etc. Another attribute in the design of a shoe insert is grip provided to the user's foot and between the shoe insert and the shoe. To maximize the grip, projections have been incorporated on an upper surface of the shoe insert for increasing a coefficient of friction between the user's foot and the upper surface of the shoe insert. In most cases, the shoe insert includes protruding structures on the upper surface of the shoe insert that provide a gripping surface to the underside of the user's foot. However, these projections or protruding structures may cause discomfort to the underside of the user's foot.

Moreover, a shoe without a shoe insert causes slippage between the material of the inner surface of the shoe and the surface of the user's foot in contact with the inner surface of the shoe during use. That is, conventional materials used to make shoe inserts do not provide sufficient friction or grip between the user's foot and the shoe insert. These conventional materials, due to their low coefficients of friction, cause slippage between the material of the shoe insert and the surface of the user's foot in contact with the shoe insert during use when these conventional materials come in contact with elements, for example, sweat from the user's foot, dust, moisture, air, etc. Furthermore, when a user walks with the shoe insert sandwiched between the user's foot and the inner surface of the shoe, the frictional force generated during walking can cause the shoe insert to slip inside the shoe since the lower surface of the shoe insert does not have a gripping surface. Therefore, there is a need for a shoe insert that provides grip between the material of the shoe insert and the surface of the user's foot in contact with the shoe insert during use to prevent slippage between the shoe insert and the surface of the user's foot in contact with the shoe insert, and that simultaneously provides grip between the shoe insert and the inner surface of the shoe to prevent slippage between the shoe insert and the inner surface of the shoe.

In athletics and sports where friction between the foot and the ground is required for optimal performance, there is a need for a shoe insert that is positioned on an inner surface of a shoe and that increases the coefficient of friction between a user's foot and the shoe insert and between the shoe insert and the inner surface of the shoe. For example, in sports that involve running, skating, etc., where the user is required to quickly or abruptly change directions while engaged in a sports activity, the user's foot tends to slip inside a shoe worn by the user due to a lack of sufficient grip between a sock enclosed foot and the shoe insert or between the user's barefoot and the shoe insert when the user decides not to wear a pair of socks, and between the shoe insert and the inner surface of the shoe, when the shoe insert is made of a conventional material and/or with conventional gripping projections on the upper surface of the shoe insert. This slippage also increases a response time when the user moves in a direction different from the direction in which the user was originally moving. Lack of sufficient grip may also cause the foot of the user playing the sport to slip or cause the foot to roll inside the shoe and suffer injuries. For example, the user's foot and the shoe insert having a conventional design and made of a conventional material may slip inside the shoe during a sharp turn leading to an ankle injury. Shoe inserts constructed using conventional materials and having conventional designs therefore do not provide sufficient grip to the user's foot when the user is engaged in a sports activity that requires sharp or abrupt turns.

Furthermore, different sports activities require a gripping contact to be established between different sections of the user's foot and a shoe worn by the user. For example, a user engaged in running would require a steady gripping contact between a forefoot portion and a rearfoot portion of the user's foot and the shoe insert. Hence, there is a need for making a non-slip shoe insert that has continuous or non-continuous non-slip sections across the entire length of the shoe insert from the heel to the toes. Furthermore, due to moisture, excessive sweat, oils, etc., produced from the user's foot which may remain on the shoe insert positioned inside the shoe, the shoe insert needs to be removed from the shoe and washed and/or ventilated.

Hence, there is a long felt but unresolved need for a washable, non-slip removable footwear insert that provides simultaneous gripping contact between an upper surface of the non-slip removable footwear insert and a user contact surface, for example, a bottom surface of the user's foot, and between a lower surface of the non-slip removable footwear insert and an inner surface of footwear, thereby preventing slippage of the user contact surface against the non-slip removable footwear insert and slippage of the non-slip removable footwear insert against the inner surface of the footwear.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The non-slip removable footwear insert disclosed herein addresses the above mentioned need for providing simultaneous gripping contact between an upper surface of the non-slip removable footwear insert and a user contact surface, for example, a bottom surface of a user's foot, and between a lower surface of the non-slip removable footwear insert and an inner surface of footwear, thereby preventing slippage of the user contact surface against the non-slip removable footwear insert and slippage of the non-slip removable footwear insert against the inner surface of the footwear. The non-slip removable footwear insert disclosed herein includes an insert member and a non-slip material applied on an upper surface and a lower surface of the insert member. The insert member conforms to and is removably positioned on an inner surface of the footwear. The upper surface of the insert member is proximal to the user contact surface and distal to the inner surface of the footwear. The lower surface of the insert member is proximal to the inner surface of the footwear and distal to the user contact surface. The non-slip material on the upper surface and the lower surface of the insert member provides simultaneous gripping contact between the upper surface of the insert member and the user contact surface, and between the lower surface of the insert member and the inner surface of the footwear. Disclosed herein is also a method for making the non-slip removable footwear insert.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1A exemplarily illustrates a top perspective view of a non-slip removable footwear insert positioned on an inner surface of footwear.

FIG. 1B exemplarily illustrates a top perspective view of the non-slip removable footwear insert positioned on an inner surface of footwear, showing a user's foot positioned on the non-slip removable footwear insert.

FIG. 2A exemplarily illustrates a top plan view of the non-slip removable footwear insert.

FIG. 2B exemplarily illustrates a bottom view of the non-slip removable footwear insert.

FIG. 2C exemplarily illustrates a sectional view of the non-slip removable footwear insert taken along a sectional line X-X shown in FIG. 2A.

FIG. 2D exemplarily illustrates a front elevation view of the non-slip removable footwear insert.

FIG. 2E exemplarily illustrates a rear elevation view of the non-slip removable footwear insert.

FIG. 2F exemplarily illustrates a right side elevation view of the non-slip removable footwear insert.

FIG. 2G exemplarily illustrates a left side elevation view of the non-slip removable footwear insert.

FIGS. 3A-3F exemplarily illustrate top perspective views of different embodiments of the configuration of the non-slip removable footwear insert.

FIGS. 4A-4G exemplarily illustrate top perspective views of different embodiments of a non-slip material applied on an insert member of the non-slip removable footwear insert.

FIG. 4H exemplarily illustrates a bottom perspective view of an embodiment of the non-slip material applied on the insert member of the non-slip removable footwear insert.

FIGS. 5A-5E exemplarily illustrate top perspective views of embodiments of the non-slip removable footwear insert, showing ventilation openings configured on one or more selected positions of the non-slip removable footwear insert.

FIG. 6 exemplarily illustrates a right side elevation view of an embodiment of the non-slip removable footwear insert, showing projections configured on a lower surface of the non-slip removable footwear insert.

FIG. 7A exemplarily illustrates an exploded view of an embodiment of the non-slip removable footwear insert, showing a hook and loop fastener attached on the lower surface of the non-slip removable footwear insert and the inner surface of the footwear.

FIG. 7B exemplarily illustrates an assembled view of the embodiment of the non-slip removable footwear insert shown in FIG. 7A.

FIG. 8A exemplarily illustrates an embodiment of the non-slip removable footwear insert, showing snap fasteners configured on a lower surface and an outer surface of the non-slip removable footwear insert.

FIG. 8B exemplarily illustrates a cutaway sectional view of footwear, showing snap fasteners positioned on inner surfaces of the footwear.

FIG. 8C exemplarily illustrates a cutaway sectional view of footwear, showing the embodiment of the non-slip removable footwear insert shown in FIG. 8A, attached to the footwear shown in FIG. 8B.

FIG. 9A exemplarily illustrates a left side elevation view of an embodiment of the non-slip removable footwear insert configured as a bootie.

FIG. 9B exemplarily illustrates a left side elevation view, showing the embodiment of the non-slip removable footwear insert configured as a bootie shown in FIG. 9A, inserted into footwear.

FIG. 9C exemplarily illustrates a sectional view of the embodiment of the non-slip removable footwear insert taken along a sectional line Y-Y shown in FIG. 9B.

FIG. 10A exemplarily illustrates a bottom perspective view of an embodiment of the non-slip removable footwear insert configured as a bootie.

FIG. 10B exemplarily illustrates a cutaway sectional view of the embodiment of the non-slip removable footwear insert configured as a bootie shown in FIG. 10A.

FIG. 11 exemplarily illustrates application of a non-slip material on the insert member to create the non-slip removable footwear insert, by pouring the non-slip material on an entire upper surface or a substantially entire upper surface of the insert member.

FIG. 12 exemplarily illustrates application of a non-slip material on the insert member to create the non-slip removable footwear insert, by spraying the non-slip material on an entire upper surface or a substantially entire upper surface of the insert member.

FIG. 13A exemplarily illustrates application of a non-slip material on the insert member to create the non-slip removable footwear insert using a design frame.

FIG. 13B exemplarily illustrates a top perspective view of the non-slip removable footwear insert, showing the non-slip material configured as rectangular shapes on the insert member.

FIG. 14A exemplarily illustrates a top perspective view of an insert member prior to sewing rectangular shaped non-slip material thereon to create the non-slip removable footwear insert.

FIG. 14B exemplarily illustrates a top perspective view of the insert member, showing the rectangular shaped non-slip material being sewn on an upper surface of the insert member to create the non-slip removable footwear insert.

FIG. 14C exemplarily illustrates a top perspective view of the non-slip removable footwear insert, showing the rectangular shaped non-slip material sewn on the upper surface of the insert member.

FIG. 14D exemplarily illustrates a sectional view of the non-slip removable footwear insert taken along a sectional line Z-Z shown in FIG. 14C.

FIG. 15A exemplarily illustrates a top perspective view of an insert member prior to application of patches of non-slip material thereon to create the non-slip removable footwear insert.

FIG. 15B exemplarily illustrates a top perspective view of the insert member, showing the patches of non-slip material being sewn on the upper surface of the insert member to create the non-slip removable footwear insert.

FIG. 15C exemplarily illustrates a top perspective view of the non-slip removable footwear insert, showing the patches of non-slip material sewn on the upper surface of the insert member.

FIG. 16A exemplarily illustrates heat pressing of a non-slip material on an entire upper surface or a substantially entire upper surface of an insert member and on an entire lower surface or a substantially entire lower surface of the insert member using a heat press.

FIG. 16B exemplarily illustrates heat pressing of a non-slip material configured into predefined shapes in contact with each other on the upper surface and the lower surface of an insert member using a heat press.

FIG. 16C exemplarily illustrates heat pressing of a non-slip material configured into predefined shapes spaced apart from each other on the upper surface and the lower surface of the insert member using a heat press.

FIG. 17 exemplarily illustrates multiple threads being separated and wound around spools for creating a knitted insert member.

FIG. 18A exemplarily illustrates knitting of a first pair comprising a first non-slip thread and a first supplementary thread with a second pair comprising a second non-slip thread and a second supplementary thread for creating a knitted insert member.

FIG. 18B exemplarily illustrates knitting the first pair and the second pair using a latch needle for creating a knitted insert member.

FIG. 19A exemplarily illustrates a top perspective view of a knitted insert member.

FIG. 19B exemplarily illustrates an enlarged view of a portion of the knitted insert member shown in FIG. 19A.

FIGS. 20A-20D exemplarily illustrate multiple views of the knitted insert member, showing a first pair comprising a first non-slip thread and a first supplementary thread knitted with a second pair comprising a second non-slip thread and a second supplementary thread.

FIG. 21A exemplarily illustrates application of a non-slip material on a knitted insert member to create a non-slip removable footwear insert by spraying the non-slip material on the knitted insert member.

FIG. 21B exemplarily illustrates an enlarged view of a sprayed portion of the knitted insert member shown in FIG. 21A.

FIG. 22 illustrates a method for making a non-slip removable footwear insert.

### DETAILED DESCRIPTION OF THE INVENTION

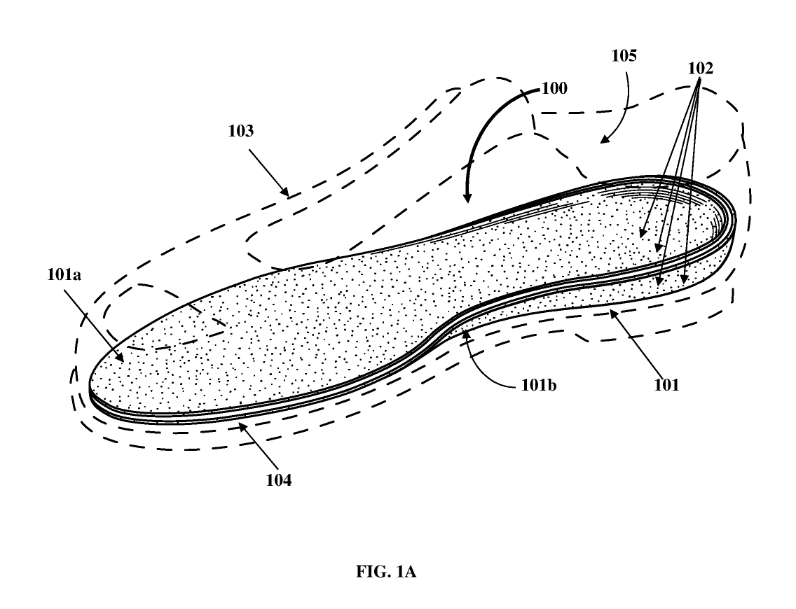

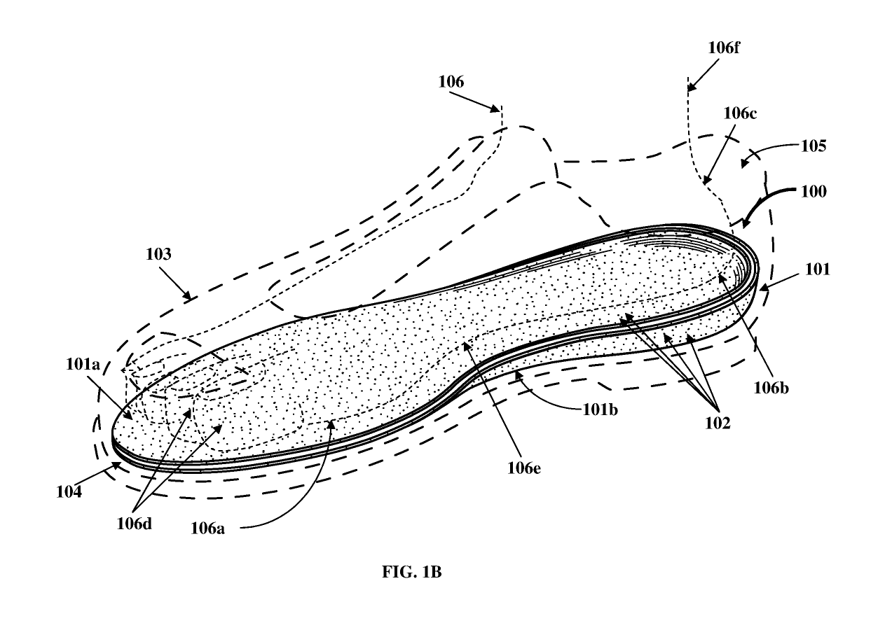

FIG. 1A exemplarily illustrates a top perspective view of a non-slip removable footwear insert 100 positioned on an inner surface 104 of footwear, herein referred to, for example, as a “shoe” and referenced by the numeral 103. As used herein, “non-slip removable footwear insert” refers to a natural or synthetic material, or a combination of both with a non-slip material 102 applied thereon, that is removably positioned adjacent to an inner surface 104 of the shoe 103. In an embodiment, the non-slip removable footwear insert 100 is removably positioned on the inner surface 104 of the shoe 103 below a user's foot 106 exemplarily illustrated in FIG. 1B. A user's foot 106 rests on the non-slip removable footwear insert 100 positioned on the inner surface 104 of the shoe 103. FIG. 1B exemplarily illustrates a top perspective view of the non-slip removable footwear insert 100 positioned on the inner surface 104 of the shoe 103, showing a user's foot 106 positioned on the non-slip removable footwear insert 100. The heel 106b, the ankle 106c, toes 106d, and a midsection 106e of the user's foot 106 are exemplarily illustrated in FIG. 1B.

As exemplarily illustrated in FIGS. 1A-1B, the non-slip removable footwear insert 100 disclosed herein comprises an insert member 101 with a non-slip material 102 applied on the upper surface 101a and the lower surface 101b of the insert member 101. The insert member 101 is configured to conform to a shape of the inner surface 104 of the shoe 103, for example, to the shape of the insole of the shoe 103. The insert member 101 is removably positioned adjacent to and directly above the inner surface 104 of the shoe 103. In an embodiment, the insert member 101 is removably positioned adjacent to and directly above the insole of the shoe 103. In an embodiment, the insert member 101 is made of a washable fabric. The insert member 101 is made of, for example, polyurethane, Nylon, neoprene, and other synthetic plastics or thermo plastic elastomers that provide comfort to a user. The insert member 101 comprises an upper surface 101a and a lower surface 101b. The upper surface 101a of the insert member 101 is proximal to a user contact surface, for example, a bottom surface 106a of a user's foot 106 and distal to the inner surface 104 of the shoe 103. As used herein, “user contact surface” refers to a surface, for example, socks worn by the user or the skin on the user's foot 106 that contacts the upper surface 101a of the insert member 101. The lower surface 101b of the insert member 101 is proximal to the inner surface 104 of the shoe 103 and distal to the user contact surface, that is, the bottom surface 106a of the user's foot 106.

The non-slip material 102 is applied on the upper surface 101a and the lower surface 101b of the insert member 101. As used herein, “non-slip material” refers to a sticky, gripping, tacky, and/or textured material that exhibits a generally high surface adhesion and provides grip between the upper surface 101a of the insert member 101 to which the non-slip material 102 is applied and the bottom surface 106a of the user's foot 106, and simultaneously provides grip between the lower surface 101b of the insert member 101 to which the non-slip material 102 is applied and the inner surface 104 of the shoe 103. Also, as used herein, “textured material” refers to any coarse or non-uniform finish material, for example, a surface produced when Styrofoam® from the Dow Chemical Company is sprayed onto the surface. In an embodiment, the non-slip material 102 is made in the form of a sheet having a thickness of, for example, about 0.35 millimeters (mm). In this embodiment, the non-slip material 102 in the form of a sheet can be attached to the upper surface 101a of the insert member 101 and the lower surface 101b of the insert member 101, for example, by sewing, using adhesives, etc. In another embodiment, the non-slip material 102 has a suede type finish and is classified as a non-woven fabric. The non-slip material 102 provides simultaneous gripping contact between the upper surface 101a of the insert member 101 and the user contact surface, and between the lower surface 101b of the insert member 101 and the inner surface 104 of the shoe 103. The upper surface 101a of the insert member 101 with the applied non-slip material 102 therefore becomes a non-slip upper surface, and the lower surface 101b of the insert member 101 with the applied non-slip material 102 becomes a non-slip lower surface.

The non-slip material 102 provides resistance against slippage between the upper surface 101a of the insert member 101 and a bottom surface 106a of the user's foot 106 inserted into a cavity 105 of the shoe 103, and between the lower surface 101b of the insert member 101 and the inner surface 104 of the shoe 103. The non-slip material 102 disclosed herein is configured to retain non-slip properties in both dry and wet conditions. In an embodiment, the non-slip material 102 is, for example, Clarino®, a product manufactured by Kuraray Co., Ltd., Tokyo, Japan, such as Clarino® KX7400 0.35 mm and other synthetic suede or leather-like materials made by Clarino® that have non-slip properties in both dry and wet conditions. The scope of the non-slip material 102 disclosed herein is not limited to Clarino® products, but may be extended to include any non-slip material 102 capable of retaining non-slip properties in both dry and wet conditions. The non-slip material 102 can also be made, for example, from natural rubber, synthetic rubber, natural latex, thermoplastic rubber (TPR), thermoplastic elastomers (TPE), polyurethane, polyvinyl chloride, materials with synthetic suede-like non-slip finishes, materials with natural suede-like non-slip finishes, etc.

The non-slip removable footwear insert 100 disclosed herein is removable and washable. The non-slip removable footwear insert 100 can be removed for washing to remove sweat and oils that accumulate on the user's foot 106, for example, while exercising, participating in a sport, etc., and for other purposes. The non-slip removable footwear insert 100 can be worn, that is, removably positioned on the inner surface 104 of the shoe 103 worn by the user, after the non-slip removable footwear insert 100 is washed. The non-slip removable footwear insert 100 disclosed herein with the non-slip material 102 is configured to be washed after each use and since the non-slip material 102 retains non-slip properties in both dry and wet conditions, the non-slip removable footwear insert 100 disclosed herein provides enhanced gripping contact between the upper surface 101a of the insert member 101 and the user contact surface, and between the lower surface 101b of the insert member 101 and the inner surface 104 of the shoe 103.

The non-slip removable footwear insert 100 disclosed herein allows a user to slide his/her foot 106 into the cavity 105 of the shoe 103 without wearing a sock, where the sole of the barefoot 106 of the user is in contact with the upper surface 101a of the non-slip removable footwear insert 100. The non-slip removable footwear insert 100 disclosed herein therefore allows barefoot use of the shoe 103. The non-slip removable footwear insert 100 disclosed herein provides grip between a sock enclosed foot and the upper surface 101a of the non-slip removable footwear insert 100 or between the user's barefoot 106 and the upper surface 101a of the non-slip removable footwear insert 100 when the user decides not to wear a pair of socks, and between the lower surface 101b of the non-slip removable footwear insert 100 and the inner surface 104 of the shoe 103 worn by the user. The application of the non-slip material 102 or a selective application of the non-slip material 102 on the upper surface 101a and the lower surface 101b of the insert member 101 to create the non-slip removable footwear insert 100 prevents the foot 106 of a user, for example, a player, a sportsman, etc., wearing the non-slip removable footwear insert 100 from slipping inside the shoe 103 by providing grip to the user's foot 106 between the foot 106 and the non-slip removable footwear insert 100. The non-slip material 102 simultaneously prevents the non-slip removable footwear insert 100 from slipping inside the shoe 103 by providing grip between the non-slip removable footwear insert 100 and the inner surface 104 of the shoe 103.

The non-slip material 102 on the upper surface 101a of the insert member 101 is configured to frictionally engage the bottom surface 106a of the user's foot 106 with or without a sock enveloping the user's foot 106, when the user's foot 106 is positioned on the non-slip removable footwear insert 100 inside the shoe 103 worn by the user, and the lower surface 101b of the insert member 101 is configured to frictionally engage the inner surface 104 of the shoe 103, when the lower surface 101b of the insert member 101 contacts the inner surface 104 of the shoe 103. The non-slip removable footwear insert 100 disclosed herein provides resistance to sliding motion between the user contact surface and the upper surface 101a of the insert member 101, and a resistance to sliding motion between the lower surface 101b of the insert member 101 and the inner surface 104 of the shoe 103. In an embodiment, the resistance to sliding motion of the non-slip material 102 is greater than the resistance to sliding motion of the insert member 101.

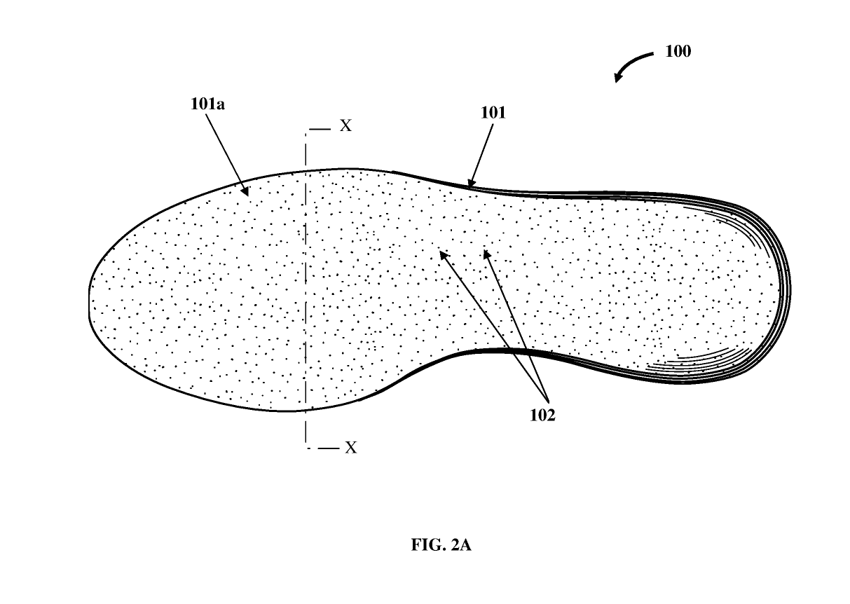

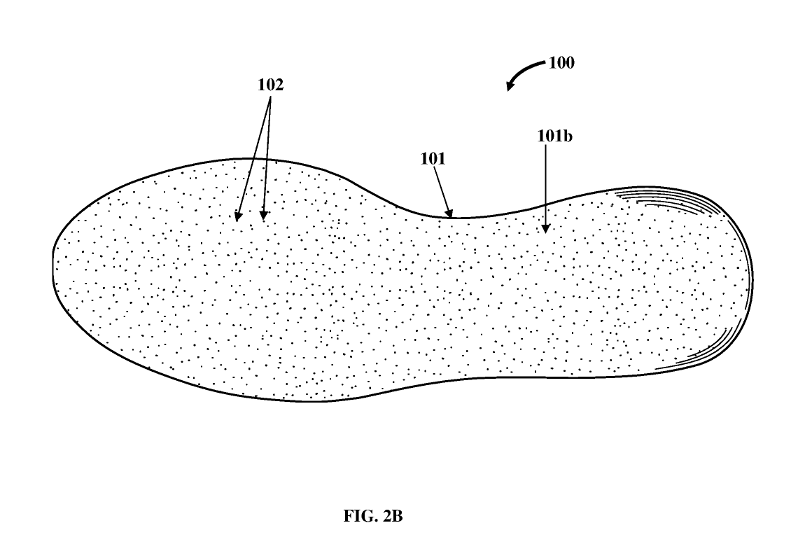

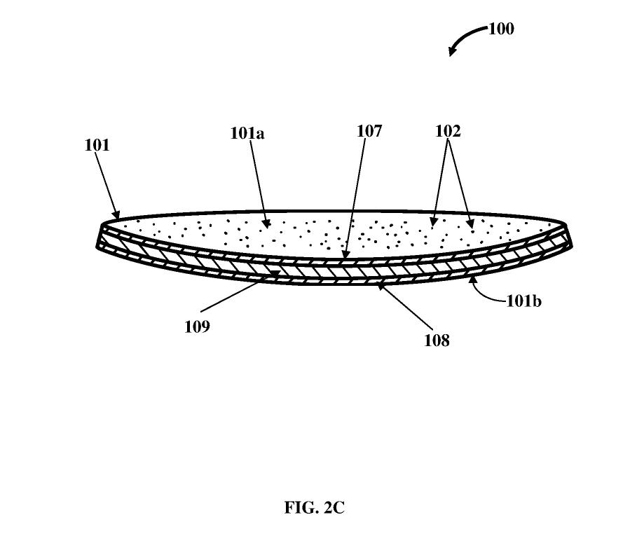

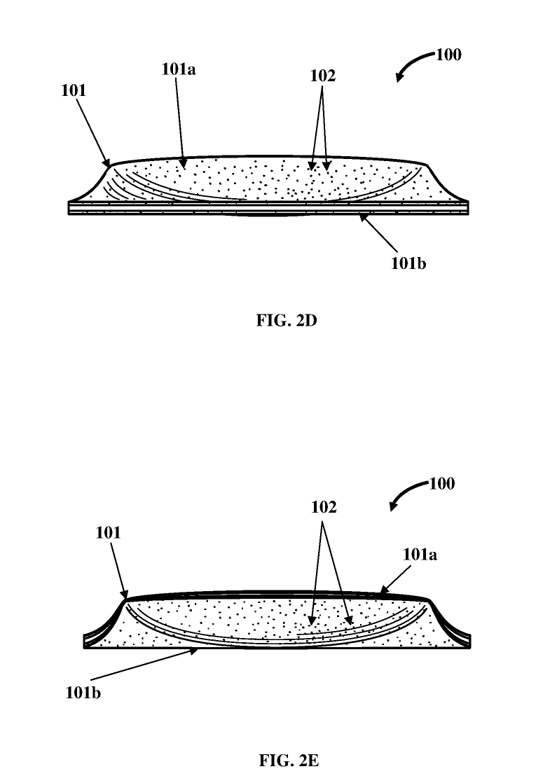

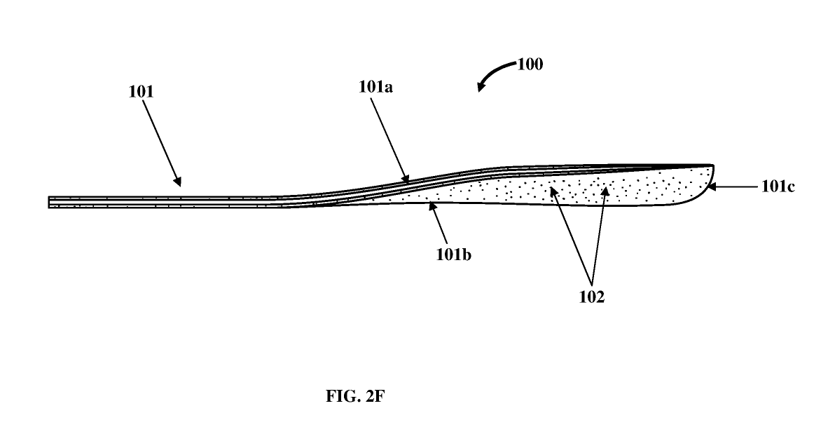

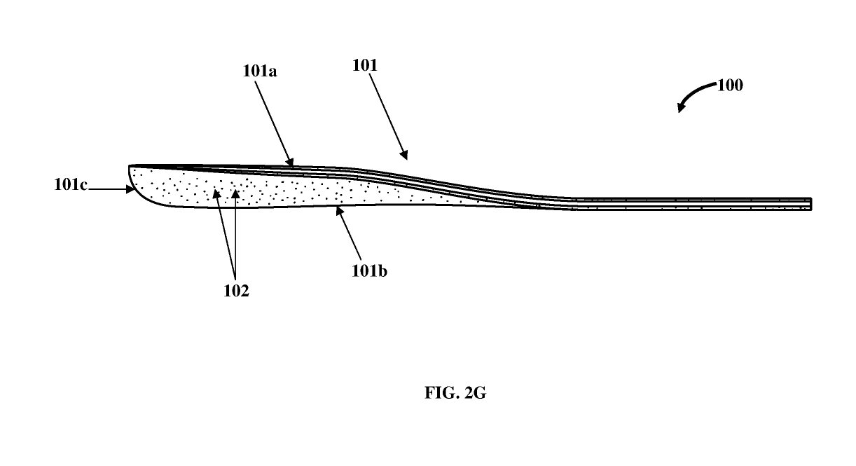

FIGS. 2A-2B exemplarily illustrates a top plan view and a bottom view of the non-slip removable footwear insert 100 respectively, showing the non-slip material 102 applied on the entire upper surface 101a and the entire lower surface 101b of the insert member 101 respectively.

FIG. 2C exemplarily illustrates a sectional view of the non-slip removable footwear insert 100 taken along a sectional line X-X shown in FIG. 2A. In an embodiment as exemplarily illustrated in FIG. 2C, the insert member 101 is configured as a three layered sheet where the three layered sheet is curved or bent upwards to form an inwardly curved upper surface 101a and an outwardly curved lower surface 101b. The upper surface 101a of the insert member 101 with the applied non-slip material 102 forms an upper layer 107 of non-slip material 102. The lower surface 101b of the insert member 101 with the applied non-slip material 102 forms a lower layer 108 of non-slip material 102. The middle layer 109 of the three layered sheet is formed of, for example, a plastic material or a foam material. In an embodiment, the non-slip material 102 applied on the upper surface 101a of the insert member 101 is similar to or the same as the non-slip material 102 applied on the lower surface 101b of the insert member 101. In another embodiment, the non-slip material 102 applied on the upper surface 101a of the insert member 101 is dissimilar to or different from the non-slip material 102 applied on the lower surface 101b of the insert member 101.

FIGS. 2D-2G exemplarily illustrate a front elevation view, a rear elevation view, a right side elevation view, and a left side elevation view of the non-slip removable footwear insert 100 respectively. In an embodiment, the non-slip material 102 is applied on the sides of a heel section 101c of the insert member 101 as exemplarily illustrated in FIGS. 2F-2G.

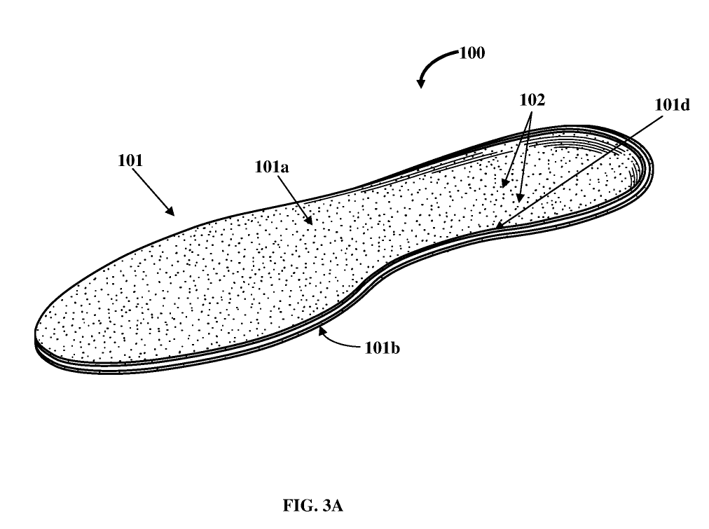

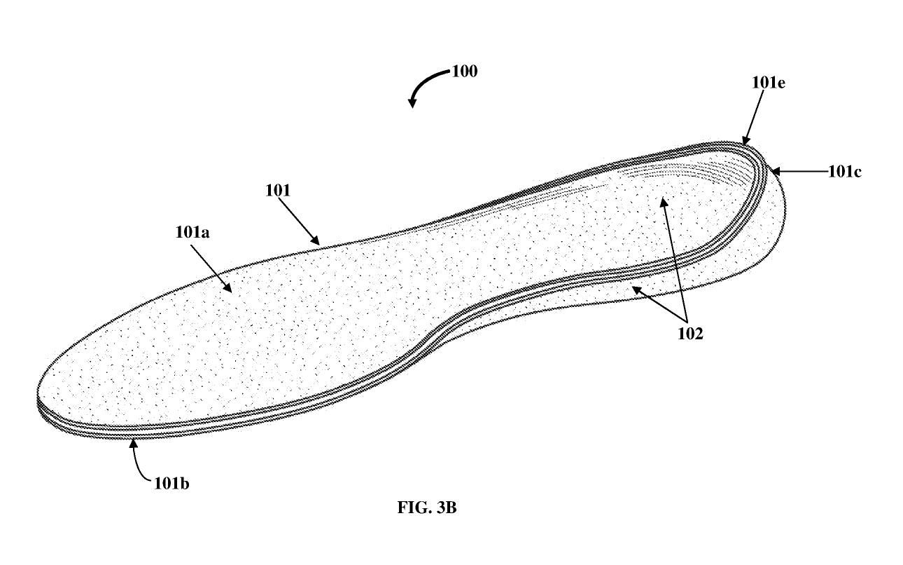

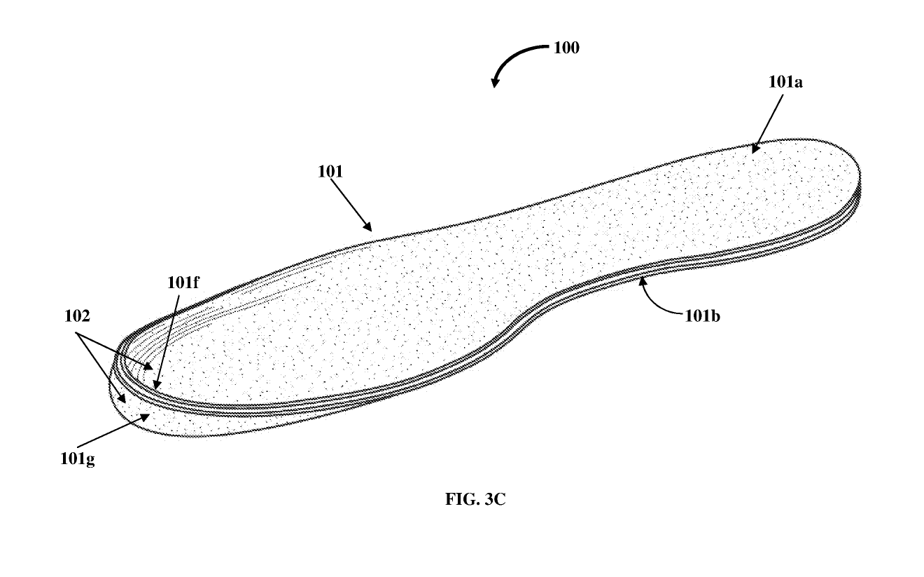

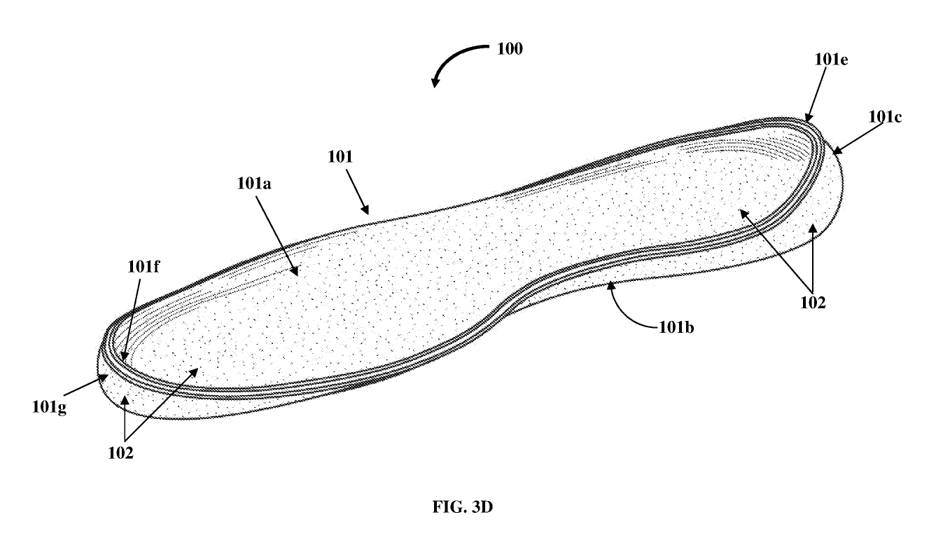

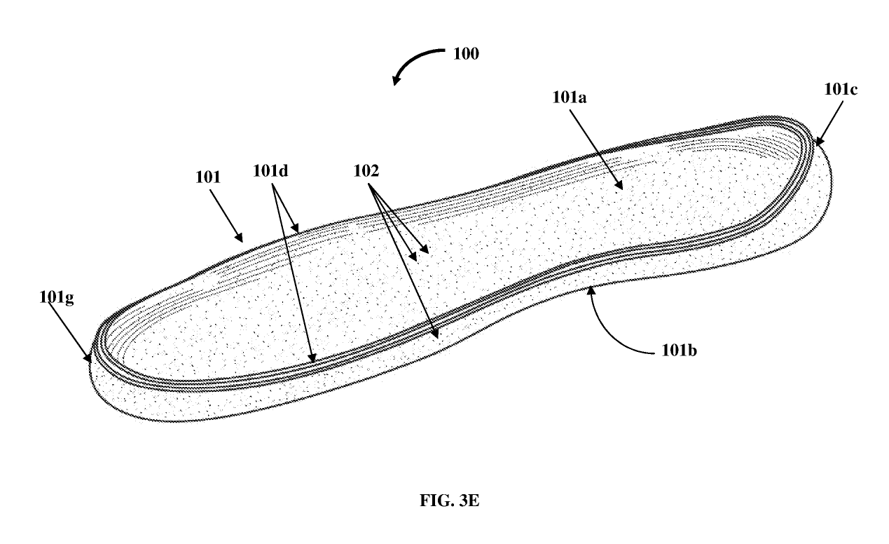

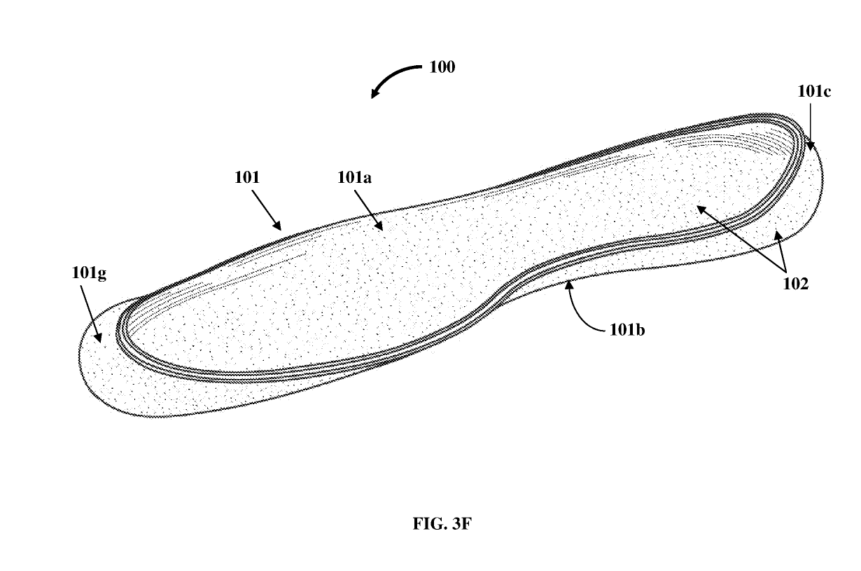

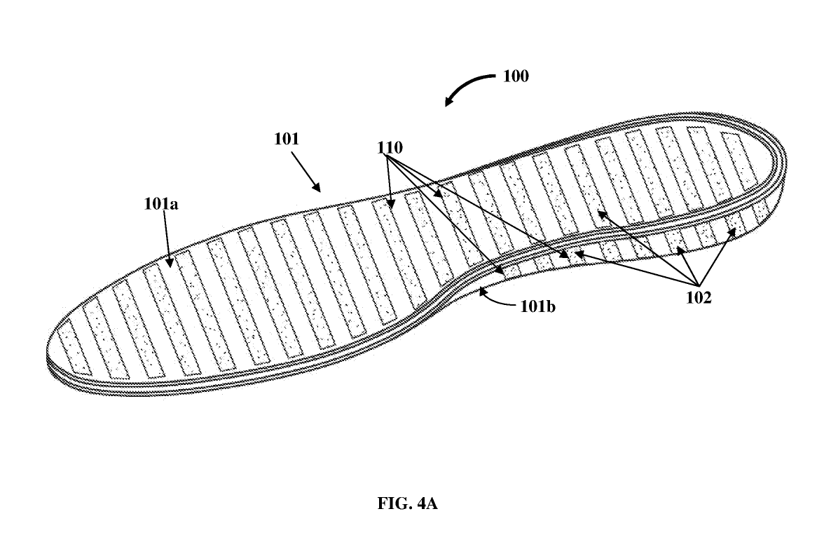

FIGS. 3A-3F exemplarily illustrate top perspective views of different embodiments of the configuration of the non-slip removable footwear insert 100. In an embodiment, the insert member 101 of the non-slip removable footwear insert 100 is configured as a flat sheet having a substantially uniform thickness across the entire surface of the insert member 101 and is not raised or curved at the periphery 101d of the insert member 101 at any section of the insert member 101 as exemplarily illustrated in FIG. 3A. In this embodiment, the insert member 101 is configured to be flat along the bottom surface 106a of the user's foot 106 exemplarily illustrated in FIG. 1B. In another embodiment, a periphery 101e at the heel section 101c of the insert member 101 is curved upwards as exemplarily illustrated in FIG. 3B. In this embodiment, the insert member 101 is configured to extend over or above the heel 106b of the user's foot 106 exemplarily illustrated in FIG. 1B. This embodiment of the insert member 101 provides additional support to the heel 106b of the user's foot 106 for applications requiring additional support to the user's ankle 106c exemplarily illustrated in FIG. 1B.

In another embodiment, a periphery 101f at a toe section 101g of the insert member 101 is curved upwards as exemplarily illustrated in FIG. 3C. In the embodiment exemplarily illustrated in FIG. 3C, the insert member 101 is also configured to be positioned flat along the bottom surface 106a of the user's foot 106, while extending over or above the user's toes 106d exemplarily illustrated in FIG. 1B. In another embodiment, the periphery 101e at the heel section 101c and the periphery 101f at the toe section 101g of the insert member 101 are curved upwards as exemplarily illustrated in FIG. 3D. In the embodiment exemplarily illustrated in FIG. 3D, the insert member 101 is configured to extend over or above the heel 106b and the toes 106d of the user's foot 106. In another embodiment, the entire periphery 101d of the insert member 101 from the heel section 101c to the toe section 101g of the insert member 101 is curved upwards to surround the user's foot 106 as exemplarily illustrated in FIG. 3E. In the embodiment exemplarily illustrated in FIG. 3E, the entire periphery 101d of the insert member 101 is configured to be extended above the user's foot 106. In another embodiment, the toe section 101g of the insert member 101 is curved upwards to cover the toes 106d of the user's foot 106 as exemplarily illustrated in FIG. 3F. In the embodiment exemplarily illustrated in FIG. 3F, the insert member 101 is configured to bend upwards to cover the toes 106d of the user's foot 106 and extend upwards along the sides of a midsection 106e and the heel 106b of the user's foot 106. Furthermore, in this embodiment, the heel section 101c is curved upwards as exemplarily illustrated in FIG. 3F. This embodiment provides additional support and protection to the user's foot 106. In the embodiments of the non-slip removable footwear insert 100 exemplarily illustrated in FIGS. 3A-3F, the non-slip material 102 is applied on the entire upper surface 101a or a substantially entire upper surface 101a of the insert member 101 and on the entire lower surface 101b or a substantially entire lower surface 101b of the insert member 101.

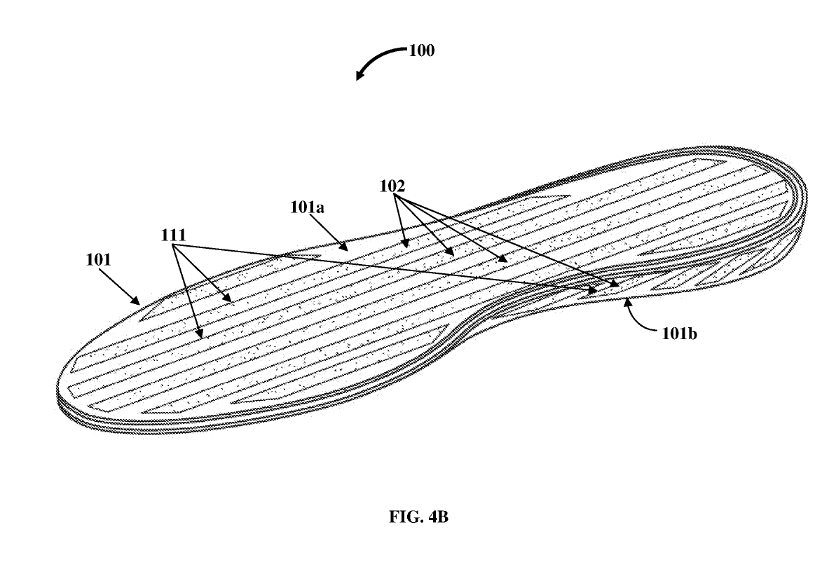

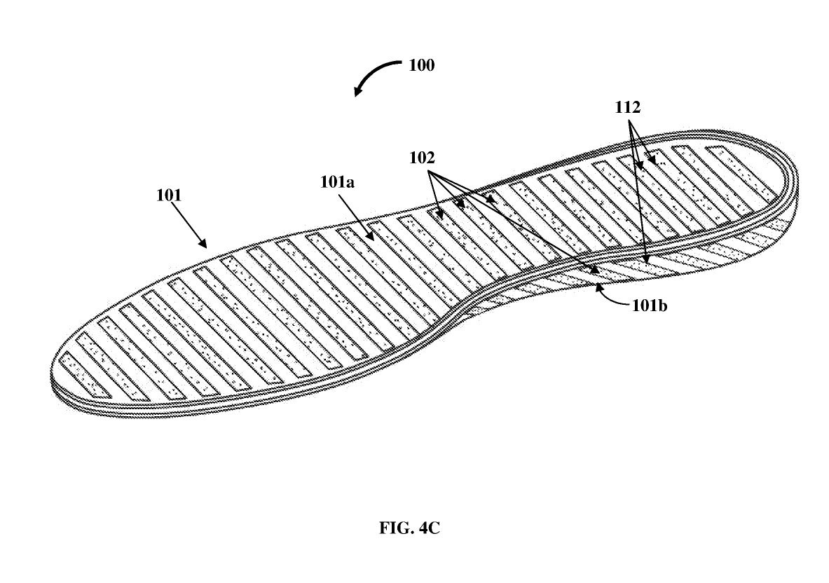

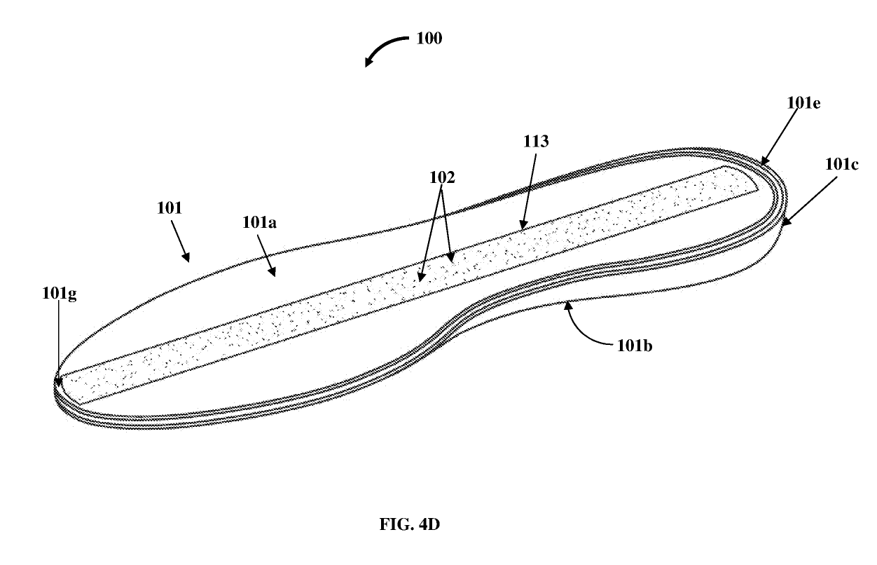

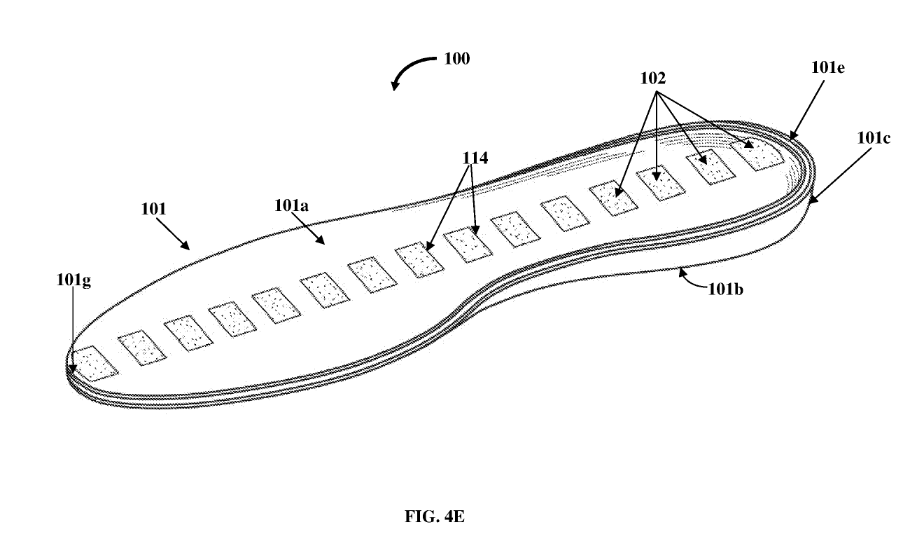

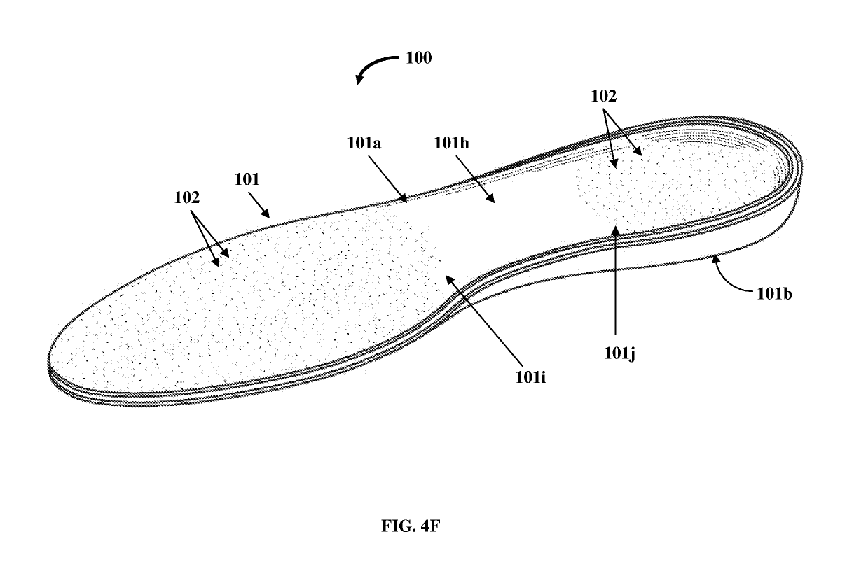

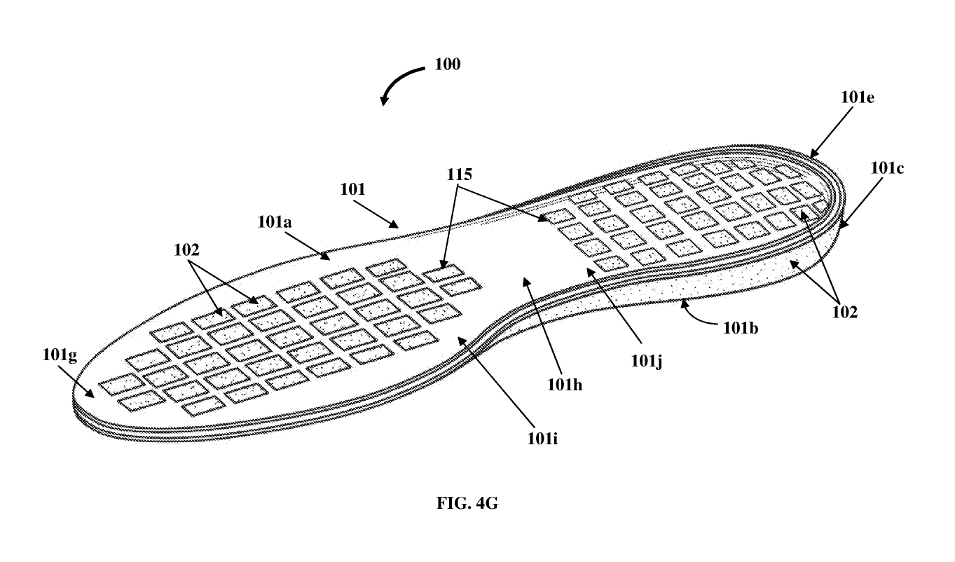

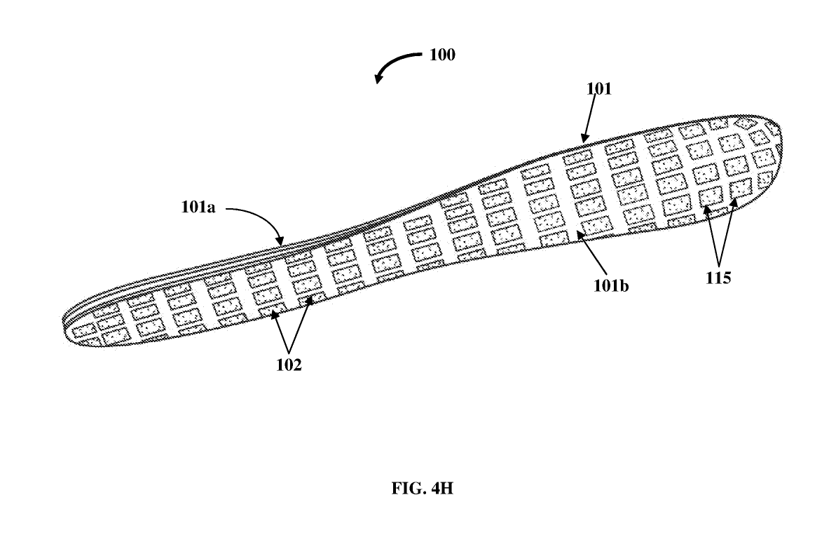

FIGS. 4A-4G exemplarily illustrate top perspective views of different embodiments of a non-slip material 102 applied on the insert member 101 of the non-slip removable footwear insert 100. In an embodiment, the non-slip material 102 is applied or attached on selective continuous portions, or on selective non-continuous portions, or on whole portions of the upper surface 101a and the lower surface 101b of the insert member 101 to create one or more selective continuous non-slip surfaces or selective non-continuous non-slip surfaces or a whole non-slip surface on the upper surface 101a and the lower surface 101b of the insert member 101 as exemplarily illustrated in FIGS. 4A-4H. As used herein, “selective continuous portions” refer to continuous portions of the upper surface 101a and the lower surface 101b of the insert member 101 selected to provide grip to certain sections of a user's foot 106 exemplarily illustrated in FIG. 1B. For example, a selective continuous portion is a continuous portion running from a heel section 101c to a toe section 101g of the upper surface 101a and the lower surface 101b of the insert member 101. The selective continuous non-slip surfaces created by application of the non-slip material 102 on the selective continuous portions of the upper surface 101a of the insert member 101 provide selective grip to corresponding sections on the bottom surface 106a of the user's foot 106 that come in contact with the selective continuous portions of the upper surface 101a of the insert member 101, while the selective continuous non-slip surfaces created by application of the non-slip material 102 on the selective continuous portions of the lower surface 101b of the insert member 101 provide selective grip to corresponding sections on the inner surface 104 of the shoe 103 exemplarily illustrated in FIG. 1B, that come in contact with the selective continuous portions of the lower surface 101b of the insert member 101.

Also, as used herein, “selective non-continuous portions” refers to non-continuous portions of the upper surface 101a and the lower surface 101b of the insert member 101 selected to provide grip to certain sections of the user's foot 106. For example, a selective non-continuous portion is a non-continuous portion running from a heel section 101c to a toe section 101g of the upper surface 101a and the lower surface 101b of the insert member 101. The selective non-continuous non-slip surfaces created by application of the non-slip material 102 on the selective non-continuous portions of the upper surface 101a of the insert member 101 provide selective grip to corresponding sections on the bottom surface 106a of the user's foot 106 that come in contact with the selective non-continuous portions of the upper surface 101a of the insert member 101, while the selective non-continuous non-slip surfaces created by application of the non-slip material 102 on the selective non-continuous portions of the lower surface 101b of the insert member 101 provide selective grip to corresponding sections on the inner surface 104 of the shoe 103, that come in contact with the selective non-continuous portions of the lower surface 101b of the insert member 101.

Also, as used herein, “whole portions” refers to the entire or substantially the entire upper surface 101a and the entire or substantially the entire lower surface 101b of the insert member 101. The whole non-slip surface created by application of the non-slip material 102 on the whole portion of the upper surface 101a of the insert member 101 provides a complete grip to the entire bottom surface 106a of the user's foot 106 that comes in contact with the whole portion of the upper surface 101a of the insert member 101, while the whole non-slip surface created by application of the non-slip material 102 on the whole portion of the lower surface 101b of the insert member 101 provides a complete grip to the entire inner surface 104 of the shoe 103 that comes in contact with the whole portion of the lower surface 101b of the insert member 101. In an embodiment, the non-slip material 102 is applied to only the upper surface 101a of the insert member 101 to provide a gripping contact between the upper surface 101a of the insert member 101 and the user contact surface, for example, the bottom surface 106a of the user's foot 106 exemplarily illustrated in FIG. 1B, and not on the lower surface 101b of the insert member 101. In this embodiment, the lower surface 101b of the insert member 101 is attached to the inner surface 104 of the shoe 103 exemplarily illustrated in FIGS. 1A-1B, for example, using fasteners, adhesives, etc.

The selective continuous portions of the upper surface 101a and the lower surface 101b of the insert member 101 with the applied non-slip material 102 provide grip to the sections of the user's foot 106 that come in contact with the selective continuous portions of the insert member 101 where the non-slip material 102 is applied. In an embodiment, the non-slip material 102 is configured into continuous strips 110 and attached horizontally on the upper surface 101a and on the lower surface 101b of the insert member 101 to create selective continuous non-slip surfaces on both the upper surface 101a and the lower surface 101b of the insert member 101 as exemplarily illustrated in FIG. 4A. The continuous strips 110 of the non-slip material 102 are positioned horizontally and spaced, for example at equal intervals on the upper surface 101a and on the lower surface 101b of the insert member 101 as exemplarily illustrated in FIG. 4A.

In another embodiment, the non-slip material 102 is configured into continuous strips 111 and attached vertically on the upper surface 101a and on the lower surface 101b of the insert member 101 to create selective continuous non-slip surfaces on both the upper surface 101a and the lower surface 101b of the insert member 101 as exemplarily illustrated in FIG. 4B. The continuous strips 111 of the non-slip material 102 are positioned vertically and spaced, for example, at equal intervals on the upper surface 101a and on the lower surface 101b of the insert member 101 as exemplarily illustrated in FIG. 4B. In another embodiment, the non-slip material 102 is configured into continuous strips 112 and attached diagonally on the upper surface 101a and on the lower surface 101b of the insert member 101 to create selective continuous non-slip surfaces on both the upper surface 101a and the lower surface 101b of the insert member 101 as exemplarily illustrated in FIG. 4C. The continuous strips 112 of the non-slip material 102 are positioned diagonally and spaced, for example, at equal intervals on the upper surface 101a and on the lower surface 101b of the insert member 101 as exemplarily illustrated in FIG. 4C.

The selective continuous non-slip surfaces created by the continuous strips 110, 111, and 112 of the non-slip material 102 on the upper surface 101a and the lower surface 101b of the insert member 101 exemplarily illustrated in FIGS. 4A-4C, provide simultaneous gripping contact between the upper surface 101a of the insert member 101 and the user contact surface, for example, the bottom surface 106a of the user's foot 106 exemplarily illustrated in FIG. 1B, and between the lower surface 101b of the insert member 101 and the inner surface 104 of the shoe 103 exemplarily illustrated in FIGS. 1A-1B. Although the detailed description refers to the continuous strips 110, 111, and 112 of the non-slip material 102 being attached horizontally, vertically, and diagonally as exemplarily illustrated in FIGS. 4A-4C, the scope of the non-slip removable footwear insert 100 disclosed herein is not limited to the continuous strips 110, 111, and 112 of the non-slip material 102 being attached horizontally, vertically, and diagonally as exemplarily illustrated in FIGS. 4A-4C, but may be extended to being attached in any orientation on both the upper surface 101a and the lower surface 101b of the insert member 101.

In another embodiment, the non-slip material 102 is configured as a single continuous strip 113 and is applied to extend from a periphery 101e of the heel section 101c to the toe section 101g on the upper surface 101a of the insert member 101 as exemplarily illustrated in FIG. 4D. This single continuous strip 113 of the non-slip material 102 positioned and attached on the upper surface 101a of the insert member 101 provides a gripping contact to the bottom surface 106a of the user's foot 106, for example, from the heel 106b to the toes 106d of the user's foot 106 exemplarily illustrated in FIG. 1B, that comes in contact with the single continuous strip 113 of the non-slip material 102. In another embodiment (not shown), the non-slip material 102 is configured as a single continuous strip (not shown) extending from the heel section 101c to the toe section 101g on the lower surface 101b of the insert member 101. The single continuous strip of the non-slip material 102 positioned and attached on the lower surface 101b of the insert member 101 provides a gripping contact to a portion of the inner surface 104 of the shoe 103 that comes in contact with the single continuous strip of the non-slip material 102 on the lower surface 101b of the insert member 101. In another embodiment (not shown), the single continuous strip of the non-slip material 102 is positioned and attached on both the upper surface 101a and the lower surface 101b of the insert member 101 to provide simultaneous gripping contact to a portion of the bottom surface 106a of the user's foot 106 and the inner surface 104 of the shoe 103 that come in contact with the single continuous strip of the non-slip material 102 on the upper surface 101a and the lower surface 101b of the insert member 101.

In another embodiment, the non-slip material 102 is configured as a single non-continuous strip 114 and applied to extend from the periphery 101e of the heel section 101c to the toe section 101g on the upper surface 101a of the insert member 101 as exemplarily illustrated in FIG. 4E. This single non-continuous strip 114 of the non-slip material 102 positioned and attached on the upper surface 101a of the insert member 101 provides a selective gripping contact to the bottom surface 106a of the user's foot 106, for example, from the heel 106b to the toes 106d of the user's foot 106, that comes in contact with the single non-continuous strip 114 of the non-slip material 102. In this embodiment, the single non-continuous strip 114 of the non-slip material 102 is configured, for example, as rectangular tabs spaced equally apart extending from the heel section 101c to the toe section 101g of the insert member 101 as exemplarily illustrated in FIG. 4E. In another embodiment (not shown), the non-slip material 102 is configured as a single non-continuous strip 114 extending from the heel section 101c to the toe section 101g on the lower surface 101b of the insert member 101. The single non-continuous strip 114 of the non-slip material 102 positioned and attached on the lower surface 101b of the insert member 101 provides selective gripping contact to a portion of the inner surface 104 of the shoe 103 that comes in contact with the single non-continuous strip 114 of the non-slip material 102 on the lower surface 101b of the insert member 101. In another embodiment (not shown), the single non-continuous strip 114 of the non-slip material 102 is positioned on both the upper surface 101a and the lower surface 101b of the insert member 101 to provide a simultaneous selective gripping contact to a portion of the bottom surface 106a of the user's foot 106 and the inner surface 104 of the shoe 103 that come in contact with the single non-continuous strip 114 of the non-slip material 102 on the upper surface 101a and the lower surface 101b of the insert member 101.

In another embodiment, the non-slip material 102 is applied on selective continuous portions 101i and 101j of the upper surface 101a of the insert member 101 as exemplarily illustrated in FIG. 4F. For example, the non-slip material 102 is sprayed on a forefoot portion 101i and a rearfoot portion 101j of the upper surface 101a of the insert member 101 as exemplarily illustrated in FIG. 4F, to provide gripping contact to a forefoot area and a rearfoot area comprising the heel 106b of the user's foot 106 exemplarily illustrated in FIG. 1B, that come in contact with the sprayed non-slip material 102. In this example, the midsection 101h of the upper surface 101a of the insert member 101 is free of the non-slip material 102 as exemplarily illustrated in FIG. 4F. In another embodiment (not shown), the non-slip material 102 is applied on selective continuous portions of the lower surface 101b of the insert member 101. For example, the non-slip material 102 is sprayed on a forefoot portion (not shown) and a rearfoot portion (not shown) of the lower surface 101b of the insert member 101 to provide gripping contact to portions of the inner surface 104 of the shoe 103 that come in contact with the non-slip material 102 sprayed on the forefoot portion and the rearfoot portion of the lower surface 101b of the insert member 101. In another embodiment (not shown), the non-slip material 102 is sprayed on the forefoot portion 101i and the rearfoot portion 101j on the upper surface 101a of the insert member 101, and on the forefoot portion (not shown) and the rearfoot portion (not shown) of the lower surface 101b of the insert member 101 to provide simultaneous gripping contact to the forefoot area and the rearfoot area of the bottom surface 106a of the user's foot 106 and the portions of the inner surface 104 of the shoe 103 that come in contact with the non-slip material 102 on the upper surface 101a and the lower surface 101b of the insert member 101.

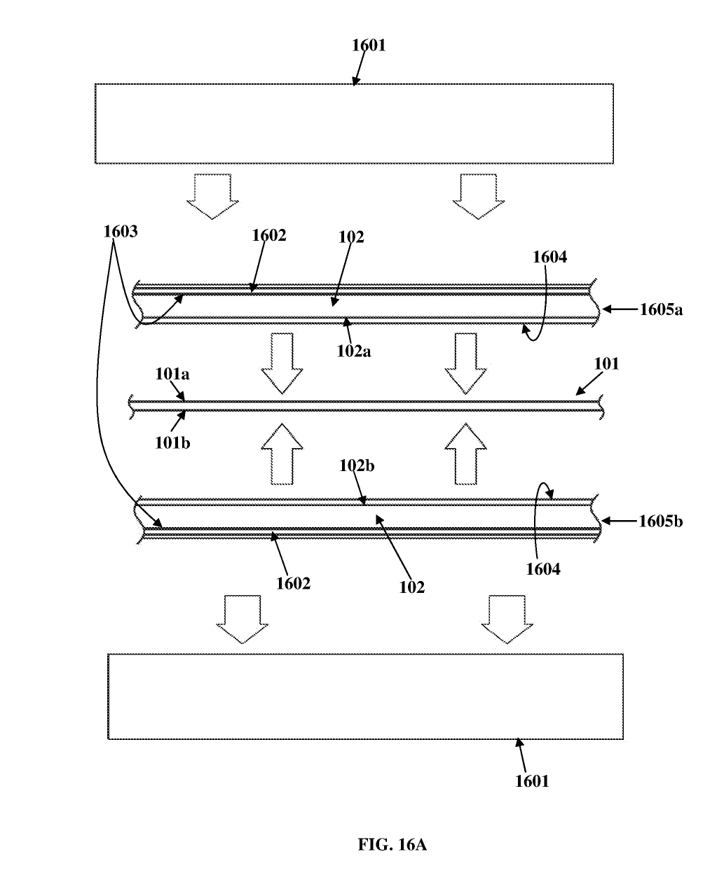

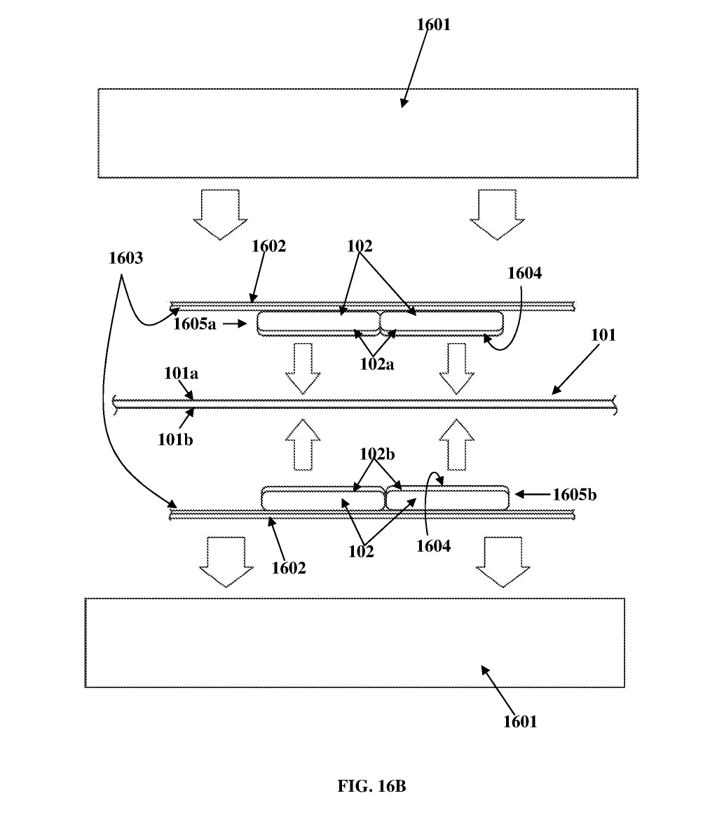

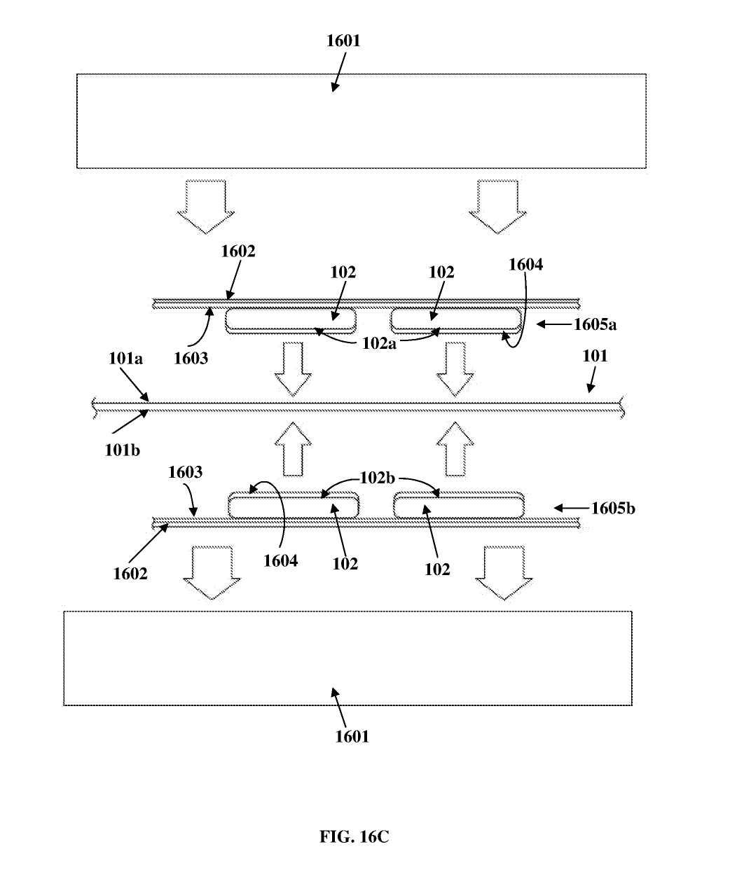

FIG. 4G exemplarily illustrates a top perspective view of an embodiment of the non-slip removable footwear insert 100, showing the non-slip material 102 configured as rectangular tabs 115 and applied, for example, heat pressed on selective portions, for example, a rearfoot portion 101j proximal to the periphery 101e of the heel section 101c and a forefoot portion 101i proximal to the toe section 101g on the upper surface 101a of the insert member 101 in a pattern. In this embodiment, the non-slip material 102 sprayed on the lower surface 101b of the insert member 101. Heat pressing is a method of applying heat and pressure on the insert member 101 for a predetermined period of time for transferring the non-slip material 102 to the upper surface 101a and the lower surface 101b of the insert member 101. Heat pressing is performed using a heat press 1601 as exemplarily illustrated in FIGS. 16A-16C. In an example, the rectangular tabs 115 of the non-slip material 102 are heat pressed on the forefoot portion 101i and the rearfoot portion 101j on the upper surface 101a of the insert member 101 as exemplarily illustrated in FIG. 4G, to provide gripping contact to a forefoot area and a rearfoot area comprising the heel 106b of the user's foot 106 exemplarily illustrated in FIG. 1B, that come in contact with the non-slip material 102. In this example, the midsection 101h of the upper surface 101a of the insert member 101 is free of the rectangular tabs 115 of the non-slip material 102. Furthermore, the non-slip material 102 sprayed on the lower surface 101b of the insert member 101 provides gripping contact to the inner surface 104 of the shoe 103 exemplarily illustrated in FIGS. 1A-1B, that comes in contact with the sprayed non-slip material 102. When the user's foot 106 is positioned on the non-slip removable footwear insert 100 exemplarily illustrated in FIG. 4G, the rectangular tabs 115 of the non-slip material 102 applied on the forefoot portion 101i and the rearfoot portion 101j of the upper surface 101a of the insert member 101 in a pattern adheres to the forefoot area and the rearfoot area comprising the heel 106b of the user's foot 106 exemplarily illustrated in FIG. 1B, that come in contact with the rectangular tabs 115 of the non-slip material 102, while the non-slip material 102 sprayed on the lower surface 101b of the insert member 101 adheres to the inner surface 104 of the shoe 103, thereby providing simultaneous grip between the rectangular tabs 115 of the non-slip material 102 on the upper surface 101a of the insert member 101 and the bottom surface 106a of the user's foot 106 at the forefoot area and the rearfoot area of the user's foot 106, and between the lower surface 101b of the insert member 101 and the inner surface 104 of the shoe 103.

In another embodiment (not shown), the non-slip material 102 is applied on selective portions on the lower surface 101b of the insert member 101. For example, the rectangular tabs 115 of the non-slip material 102 are heat pressed on a forefoot portion (not shown) and a rearfoot portion (not shown) of the lower surface 101b of the insert member 101 to provide gripping contact to portions of the inner surface 104 of the shoe 103 that come in contact with the rectangular tabs 115 of the non-slip material 102 heat pressed on the forefoot portion and the rearfoot portion of the lower surface 101b of the insert member 101. In another embodiment (not shown), the rectangular tabs 115 of the non-slip material 102 are heat pressed on a forefoot portion 101i and a rearfoot portion 101j of the upper surface 101a of the insert member 101 and on the forefoot portion (not shown) and the rearfoot portion (not shown) of the lower surface 101b of the insert member 101 to provide simultaneous gripping contact to the forefoot area and the rearfoot area of the bottom surface 106a of the user's foot 106 and the portions of the inner surface 104 of the shoe 103, that come in contact with the rectangular tabs 115 of the non-slip material 102 heat pressed on the upper surface 101a and the lower surface 101b of the insert member 101.

FIG. 4H exemplarily illustrates a bottom perspective view of an embodiment of the non-slip material 102 applied on the insert member 101 of the non-slip removable footwear insert 100. In this embodiment, the non-slip material 102 is configured into rectangular tabs 115 and applied, for example, heat pressed on a whole portion, that is, the entire lower surface 101b of the insert member 101. In an example, the rectangular tabs 115 of the non-slip material 102 are spaced at equal intervals and heat pressed on the entire lower surface 101b of the insert member 101 as exemplarily illustrated in FIG. 4H, to provide gripping contact to the inner surface 104 of the shoe 103 exemplarily illustrated in FIGS. 1A-1B, that comes in contact with the rectangular tabs 115 of the non-slip material 102. When the non-slip removable footwear insert 100 exemplarily illustrated in FIG. 4H is positioned on the inner surface 104 of the shoe 103, the rectangular tabs 115 of the non-slip material 102 on the entire lower surface 101b of the insert member 101 adhere to the inner surface 104 of the shoe 103, thereby providing grip between the rectangular tabs 115 of the non-slip material 102 on the entire lower surface 101b of the insert member 101 and the inner surface 104 of the shoe 103.

In another embodiment (not shown), the non-slip material 102 is configured into rectangular tabs 115 and applied, for example, heat pressed on a whole portion, that is, the entire upper surface 101a of the insert member 101. In an example, the rectangular tabs 115 of the non-slip material 102 are spaced at equal intervals and heat pressed on the entire upper surface 101a of the insert member 101 to provide gripping contact to the bottom surface 106a of the user's foot 106 exemplarily illustrated in FIG. 1B, that comes in contact with the rectangular tabs 115 of the non-slip material 102. When the user's foot 106 is positioned on the non-slip removable footwear insert 100 in this embodiment, the rectangular tabs 115 of the non-slip material 102 applied on the entire upper surface 101a of the insert member 101 adhere to the bottom surface 106a of the user's foot 106, thereby providing grip between the rectangular tabs 115 of the non-slip material 102 on the entire upper surface 101a of the insert member 101 and the bottom surface 106a of the user's foot 106.

In another embodiment (not shown), the rectangular tabs 115 of the non-slip material 102 are heat pressed on both the entire upper surface 101a of the insert member 101 and the entire lower surface 101b of the insert member 101 to provide simultaneous gripping contact between the entire upper surface 101a of the insert member 101 and the bottom surface 106a of the user's foot 106, and between the entire lower surface 101b of the insert member 101 and the inner surface 104 of the shoe 103. In an embodiment, the non-slip material 102 on the upper surface 101a and the lower surface 101b of the insert member 101 can be, for example, glued, sprayed continuously, stitched or heat pressed, in one large sheet on the entire upper surface 101a and the entire lower surface 101b of the insert member 101 that a user's barefoot 106 or sock enclosed foot rests on.

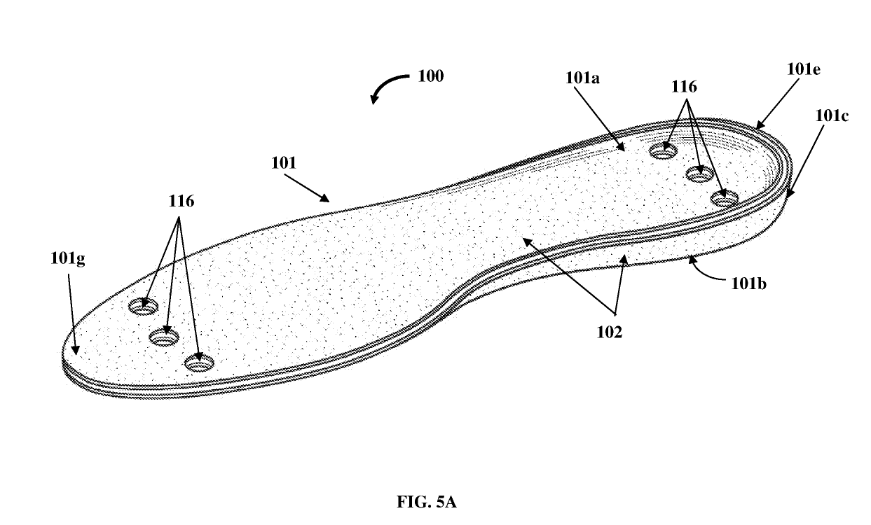

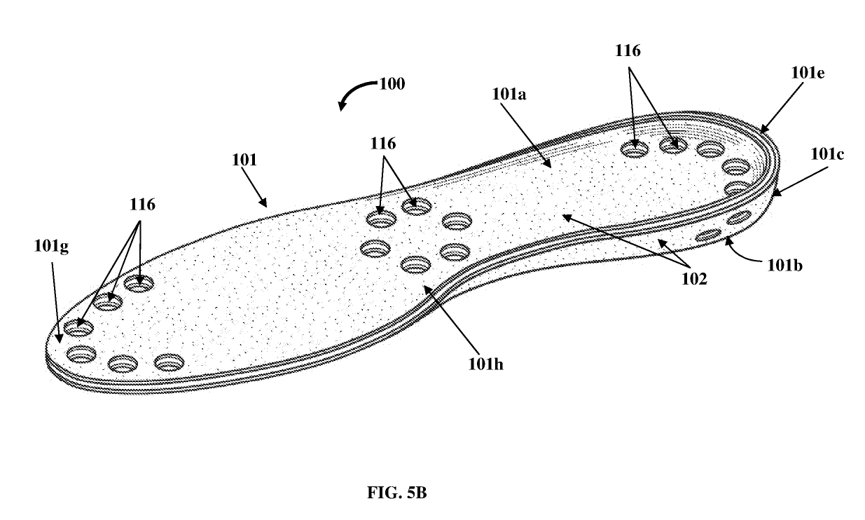

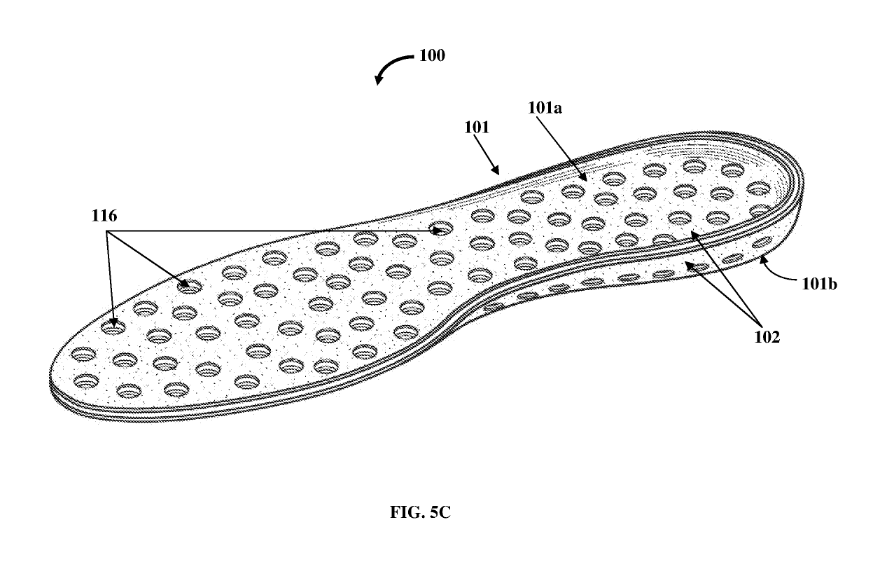

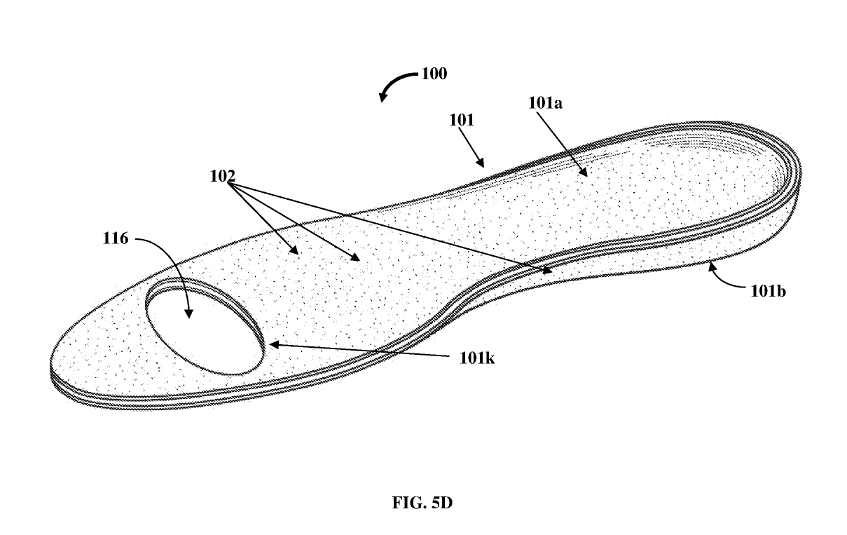

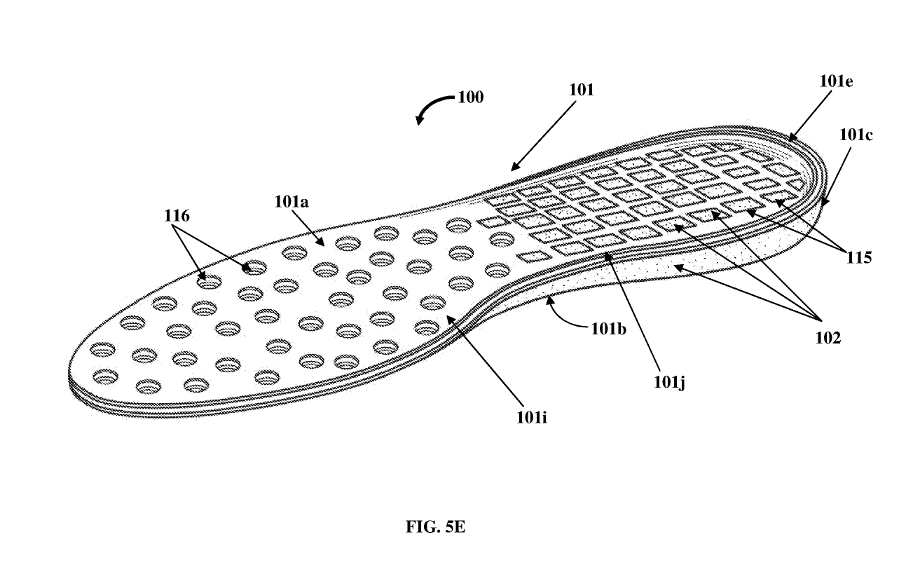

FIGS. 5A-5E exemplarily illustrate top perspective views of embodiments of the non-slip removable footwear insert 100, showing ventilation openings 116 configured on one or more selected positions of the non-slip removable footwear insert 100. In an embodiment, the non-slip removable footwear insert 100 disclosed herein further comprises one or more ventilation openings 116 or perforations configured or punched on one or more selected positions of the insert member 101 for providing ventilation to a user's foot 106 inserted into the cavity 105 of the shoe 103 exemplarily illustrated in FIG. 1B, and positioned on the non-slip removable footwear insert 100. In this embodiment, the ventilation openings 116 are created by punching holes in the insert member 101 from the upper surface 101a of the insert member 101 to the lower surface 101b of the insert member 101. The ventilation openings 116 are, for example, pre-established through holes configured in the insert member 101, which provide grip between the user's foot 106 and the insert member 101 and ventilate the user's foot 106. In an embodiment, the ventilation openings 116 configured in the non-slip removable footwear insert 100 on which the user's foot 106 rests provide a non-slip grip between the user's foot 106 and the inner surface 104 of the shoe 103 worn by the user exemplarily illustrated in FIGS. 1A-1B. In an embodiment, the ventilation openings 116 configured in the non-slip removable footwear insert 100 allow areas of the user's foot 106 to touch the inner surface 104 of the shoe 103 and therefore provide grip to the user's foot 106. The ventilation openings 116 configured in the non-slip removable footwear insert 100 allow the user's foot 106 to be maintained in a ventilated state to minimize sweat production on the user's foot 106.

In an embodiment, the ventilation openings 116 are created in the insert member 101 during manufacture of the insert member 101. In another embodiment, the ventilation openings 116 are configured in the insert member 101 after the insert member 101 is manufactured. In an embodiment, the ventilation openings 116 are created in the insert member 101 by punching holes in the insert member 101 using a fabric punching machine (not shown). In another embodiment, the ventilation openings 116 are created in the insert member 101 by drilling holes into the insert member 101 using a fabric drilling machine (not shown). In another embodiment, the ventilation openings 116 are created in the insert member 101 by burning holes in the insert member 101 by directing a laser beam onto the insert member 101 using a fabric laser cutting machine (not shown). In an embodiment, the ventilation openings 116 are created in multiple patterns on one or more selected positions of the insert member 101 as exemplarily illustrated in FIGS. 5A-5E.

The non-slip material 102 is applied on whole portions of the upper surface 101a and the lower surface 101b of the insert member 101 as exemplarily illustrated in FIGS. 5A-5D, or on selective portions of the upper surface 101a and the lower surface 101b of the insert member 101 as exemplarily illustrated in FIG. 5E. The ventilation openings 116 are created at one or more selected positions of the insert member 101, for example, in a pattern proximal to the periphery 101e of the heel section 101c and the toe section 101g of the insert member 101 as exemplarily illustrated in FIG. 5A, or in a pattern in multiple sections, for example, at the heel section 101c, the midsection 101h, and the toe section 101g of the insert member 101 as exemplarily illustrated in FIG. 5B. In an embodiment, the ventilation openings 116 are created on the entire insert member 101 from the upper surface 101a to the lower surface 101b of the insert member 101 as exemplarily illustrated in FIG. 5C. In another embodiment, a single ventilation opening 116 of a large size is created on a ball section 101k of the insert member 101 as exemplarily illustrated in FIG. 5D, to expose a ball portion of the user's foot 106 exemplarily illustrated in FIG. 1B, when the user's foot 106 is positioned on the non-slip removable footwear insert 100 inside the shoe 103. In another embodiment, the ventilation openings 116 are configured on the forefoot portion 101i of the insert member 101 while the non-slip material 102 configured, for example, as rectangular tabs 115 are applied or heat pressed on the rearfoot portion 101j of the insert member 101 as exemplarily illustrated in FIG. 5E, and vice versa. Moreover, in the embodiment exemplarily illustrated in FIG. 5E, the non-slip material 102 is also applied or sprayed on the heel section 101c of the insert member 101.

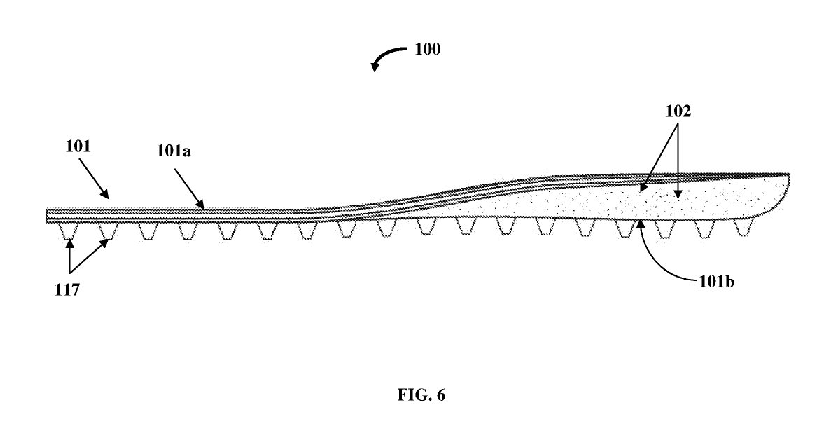

FIG. 6 exemplarily illustrates a right side elevation view of an embodiment of the non-slip removable footwear insert 100, showing projections 117 configured on the lower surface 101b of the non-slip removable footwear insert 100. The projections 117, for example, spikes exemplarily illustrated in FIG. 6, provide grip to the insert member 101 over the inner surface 104 of the shoe 103 and an enhanced grip to a user's foot 106 exemplarily illustrated in FIG. 1B. For example, a user suffering from hyperhidrosis or excessive sweating has feet that sweat profusely inside a shoe 103, which affects his/her ability to walk. To provide an improved grip to the user's foot 106 inside the shoe 103, the non-slip material 102 applied on the upper surface 101a of the insert member 101 prevents slippage of the user's foot 106 against the upper surface 101a of the insert member 101, while the lower surface 101b of the insert member 101 with the projections 117 prevent slippage of the insert member 101 against the inner surface 104 of the shoe 103.

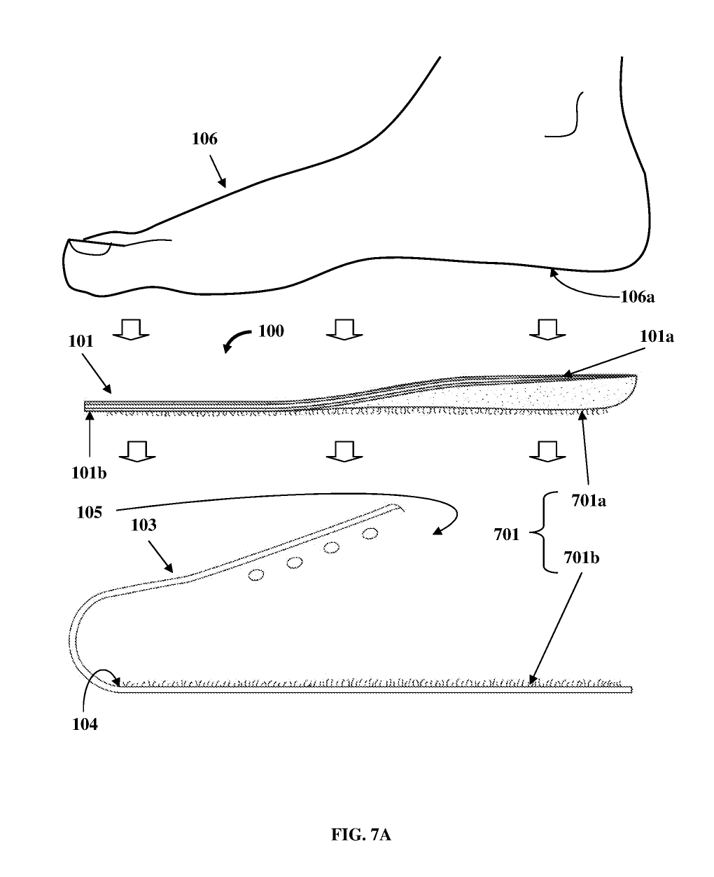

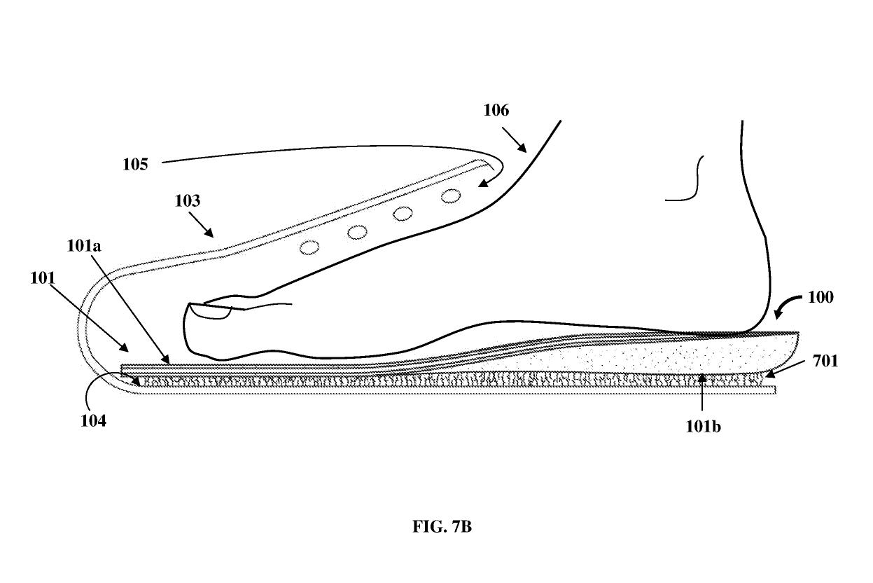

FIG. 7A exemplarily illustrates an exploded view of an embodiment of the non-slip removable footwear insert 100, showing a hook and loop fastener 701 attached on the lower surface 101b of the non-slip removable footwear insert 100 and the inner surface 104 of the shoe 103. In this embodiment, the hook and loop fastener 701 is a connector assembly comprising a hook side 701a fixedly attached on the lower surface 101b of the insert member 101 of the non-slip removable footwear insert 100, and a loop side 701b fixedly attached on the inner surface 104 of the shoe 103 as exemplarily illustrated in FIG. 7A, for example, using adhesives. The hook and loop fastener 701 fastens the non-slip removable footwear insert 100 to the inner surface 104 of the shoe 103. The hook side 701a on the lower surface 101b of the insert member 101 fixedly attaches to the loop side 701b on the inner surface 104 of the shoe 103. The hook and loop fastener 701 is, for example, a Velcro® fastener of Velcro Industries B. V. LLC, where the Velcro® fastener attached on the lower surface 101b of the insert member 101 attaches to the Velcro® fastener attached on the inner surface 104 of the shoe 103 to preclude movement between the insert member 101 and the inner surface 104 of the shoe 103. In an embodiment, the loop side 701b of the hook and loop fastener 701 is fixedly attached on the lower surface 101b of the insert member 101 of the non-slip removable footwear insert 100 and the hook side 701a is fixedly attached to the inner surface 104 of the shoe 103. When the non-slip removable footwear insert 100 is positioned inside the shoe 103 and the user's foot 106 is inserted into the cavity 105 of the shoe 103, the bottom surface 106a of the user's foot 106 contacts the upper surface 101a of the insert member 101 with the applied non-slip material 102, while the lower surface 101b of the insert member 101 with the applied non-slip material 102 contacts and is fastened to the inner surface 104 of the shoe 103 via the hook and loop fastener 701.

FIG. 7B exemplarily illustrates an assembled view of the embodiment of the non-slip removable footwear insert 100 shown in FIG. 7A. FIG. 7B exemplarily illustrates the non-slip removable footwear insert 100 fastened to an inner surface 104 of a shoe 103 via the hook and loop fastener 701. As disclosed in the detailed description of FIG. 7A, the hook and loop fastener 701 comprises the hook side 701a attached to a lower surface 101b of the insert member 101 and the loop side 701b attached to the inner surface 104 of the shoe 103. A user may first attach the insert member 101 with the applied non-slip material 102 to the inner surface 104 of the shoe 103 via the hook and loop fastener 701. To remove moisture, excessive sweat, oils, etc., produced from the user's foot 106 which may remain on the non-slip removable footwear insert 100 positioned inside the shoe 103, the non-slip removable footwear insert 100 is removed from the shoe 103 and washed and dried. The provision of the hook and loop fastener 701 for attaching the non-slip removable footwear insert 100 to the inner surface 104 of the shoe 103 allows easy removal of the non-slip removable footwear insert 100 for washing and drying purposes.

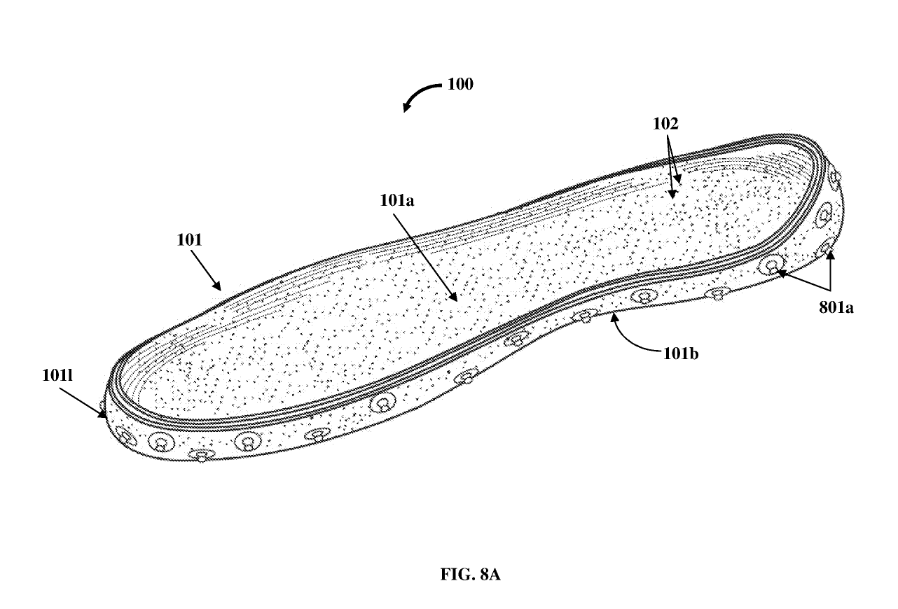

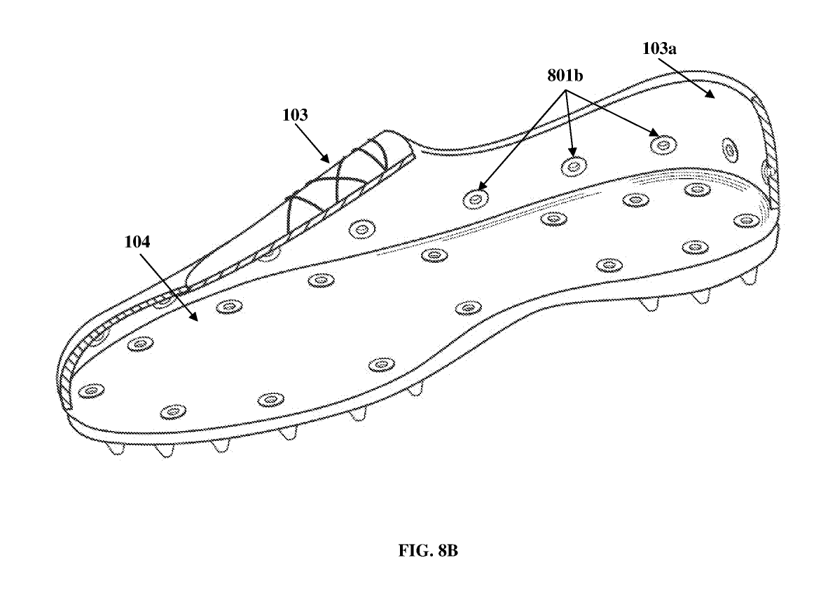

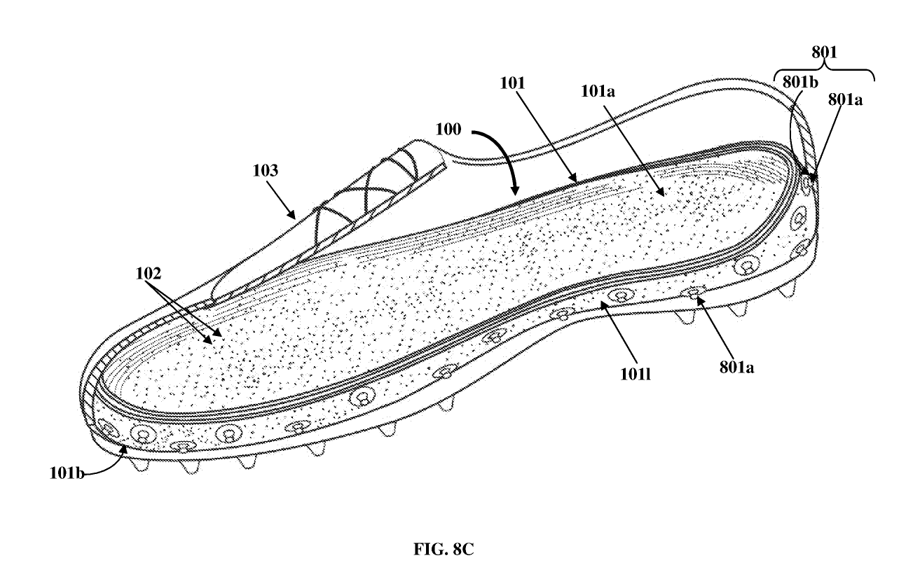

FIG. 8A exemplarily illustrates an embodiment of the non-slip removable footwear insert 100, showing snap fasteners 801 configured on a lower surface 101b and an outer surface 1011 of the non-slip removable footwear insert 100. FIG. 8B exemplarily illustrates a cutaway sectional view of the shoe 103, showing the snap fasteners 801 positioned on inner surfaces 103a and 104 of the shoe 103. FIG. 8C exemplarily illustrates a cutaway sectional view of the shoe 103, showing the embodiment of the non-slip removable footwear insert 100 shown in FIG. 8A, attached to the shoe 103 shown in FIG. 8B. In this embodiment, the snap fasteners 801 are connector assemblies operably connected on the lower surface 101b and the outer surface 1011 of the insert member 101, and on the inner surfaces 103a and 104 of the shoe 103 as exemplarily illustrated in FIGS. 8A-8C, to internally connect the non-slip removable footwear insert 100 to the shoe 103. The snap fasteners 801 fasten the non-slip removable footwear insert 100 to the inner surfaces 103a and 104 of the shoe 103. In an embodiment, each snap fastener 801 comprises a male connector 801a and a female connector 801b. In an embodiment, male connectors 801a are fixedly attached to the lower surface 101b and the outer surface 1011 of the non-slip removable footwear insert 100 as exemplarily illustrated in FIG. 8A, and female connectors 801b are fixedly attached to the inner surfaces 103a and 104 of the shoe 103 as exemplarily illustrated in FIG. 8B, or vice versa. In an embodiment, the male connectors 801a are of male puzzle shapes, while the female connectors 801b are of female puzzle shapes. The male connectors 801a mesh with or engage with the female connectors 801b to fasten the non-slip removable footwear insert 100 to the inner surfaces 103a and 104 of the shoe 103 as exemplarily illustrated in FIG. 8C. Similar to the function of the hook and loop fastener 701 exemplarily illustrated in FIGS. 7A-7B and as disclosed in the detailed description of FIGS. 7A-7B, the snap fasteners 801 allow removal of the non-slip removable footwear insert 100 from the shoe 103, for example, for washing, drying, etc.

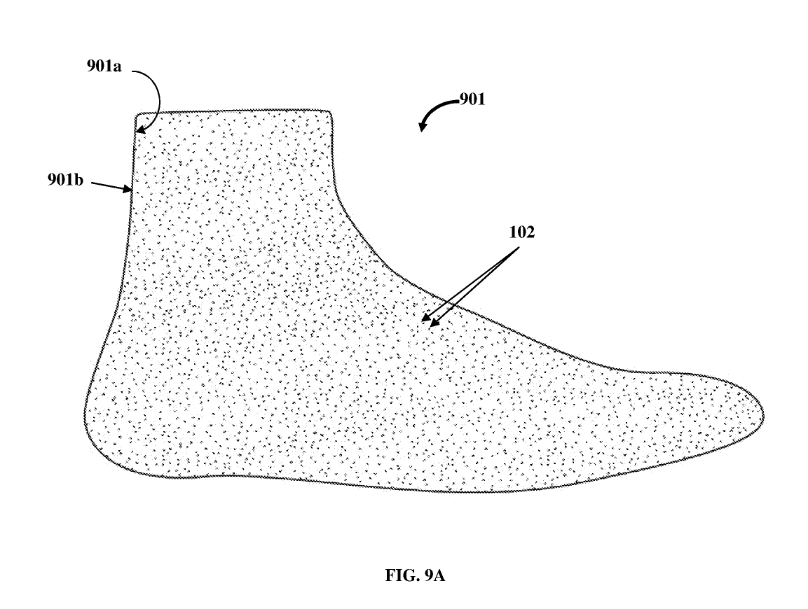

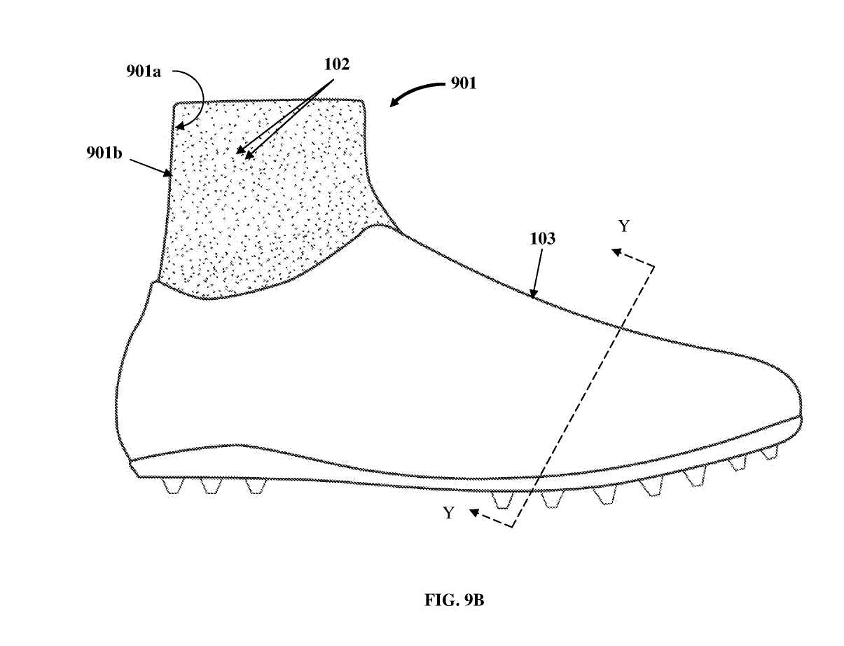

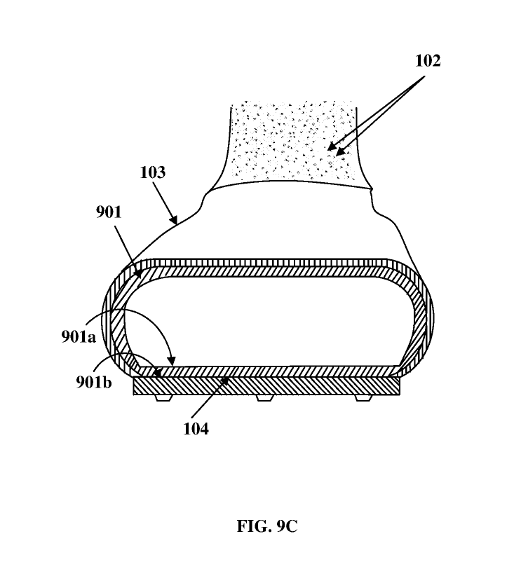

FIG. 9A exemplarily illustrates a left side elevation view of an embodiment of the non-slip removable footwear insert configured as a bootie 901. In this embodiment, the insert member 101 is configured to extend above an ankle 106c of the user's foot 106 exemplarily illustrated in FIG. 1B, and covers an entire surface area of the user's foot 106. That is, the insert member 101 is configured as a bootie 901 to envelop an entire surface area of the user's foot 106. For example, the insert member 101 is configured as a bootie 901 or a sock with the non-slip material 102 applied on opposing surfaces 901a and 901b as exemplarily illustrated in FIG. 9A. The insert member 101 can be made of one piece of neoprene material or a wetsuit material, and shaped or sewn together into a bootie shape that can be wrapped around the user's foot 106, for example, similar to a slipper. In an example, a piece of neoprene or other synthetic plastic is wrapped around a manikin's foot and sewn into the shape of a foot 106 to create a foot sleeve. The bootie 901 is configured to cover the entire foot 106 and can be extended on the ankle 106c with a fit similar, for example, to a wetsuit. FIG. 9B exemplarily illustrates the insert member 101 configured as a bootie 901 with applied non-slip material 102 and inserted into a shoe 103. As the non-slip material 102 is applied on the bootie 901 entirely, the user's foot 106 receives ankle support and grip for rough applications such as hiking, running on a moderate to bad terrain, etc.

In this embodiment, the non-slip material 102 is applied on an inner surface 901a and an outer surface 901b of the bootie 901. The non-slip material 102 on the inner surface 901a, or on the outer surface 901b, or on both the inner surface 901a and the outer surface 901b of the bootie 901 can be, for example, glued, sprayed continuously, stitched or heat pressed, in one large sheet on the entire inner surface 901a, or the entire outer surface 901b, or both the entire inner surface 901a and the entire outer surface 901b of the bootie 901 that a user's barefoot 106 or sock enclosed foot rests on. The bootie 901 has a non-slip material 102 on the inner surface 901a of the bootie 901, for example, on the side proximal to the skin of the user's foot 106.

FIG. 9B exemplarily illustrates a left side elevation view, showing the embodiment of the non-slip removable footwear insert configured as a bootie 901 shown in FIG. 9A, inserted into a shoe 103. The bootie 901 is configured to be used with different types of shoes 103, for example, rain shoes, sports shoes such as soccer shoes, basketball shoes, tennis shoes, running shoes, skate boots, ski boots, etc. The bootie 901 is configured to fit inside any type of shoe 103 and can be extended, for example, up to about 1.5 inches or about 2 inches above the shoe line. The user slips his/her foot 106 into the bootie 901 and then slips his/her foot 106 into the cavity 105 of the shoe 103 exemplarily illustrated in FIG. 1B. The inner surface 901a and the outer surface 901b of the bootie 901 are lined with the non-slip material 102. In an embodiment, the bootie 901 is provided as a lining inside the shoe 103. In an embodiment (not shown), one or more ventilation openings (not shown) are configured in one or more selected positions of the bootie 901 similar to the ventilation openings 116 configured in the non-slip removable footwear insert 100 exemplarily illustrated in FIGS. 5A-5E, to provide ventilation to a foot 106 inserted into the bootie 901.

FIG. 9C exemplarily illustrates a sectional view of the embodiment of the non-slip removable footwear insert taken along a sectional line Y-Y shown in FIG. 9B. In an embodiment, the non-slip material 102 is applied or attached on selective continuous portions, or selective non-continuous portions, or whole portions, that is, on the entire inner surface 901a and the entire outer surface 901b of the bootie 901 to provide a selective grip or a complete grip between the inner surface 901a of the bootie 901 and the user's foot 106 exemplarily illustrated in FIG. 1B, and between the outer surface 901b of the bootie 901 and the inner surface 104 of the shoe 103 exemplarily illustrated in FIG. 9B. For example, the non-slip material 102 is applied on the entire inner surface 901a and the entire outer surface 901b of the bootie 901 as exemplarily illustrated in FIGS. 9A-9B, to provide a complete grip between the inner surface 901a of the bootie 901 and the user's foot 106, and between the outer surface 901b of the bootie 901 and the inner surface 104 of the shoe 103. In an embodiment (not shown), the non-slip material 102 is applied only on the entire inner surface 901a of the bootie 901 to provide a complete grip between the inner surface 901a of the bootie 901 and the user's foot 106. In another embodiment, the non-slip material 102 is applied only on the entire outer surface 901b of the bootie 901 to provide a complete grip between the outer surface 901b of the bootie 901 and the inner surface 104 of the shoe 103. In another embodiment (not shown), the non-slip material 102 is configured, for example, as rectangular tabs, continuous strips, non-continuous strips, etc., and selectively applied on selective continuous portions or selective non-continuous portions on either the inner surface 901a of the bootie 901 or on the outer surface 901b of the bootie 901, or on both the inner surface 901a and the outer surface 901b of the bootie 901 to provide a selective grip between the inner surface 901a of the bootie 901 and the user's foot 106, and between the outer surface 901b of the bootie 901 and the inner surface 104 of the shoe 103.

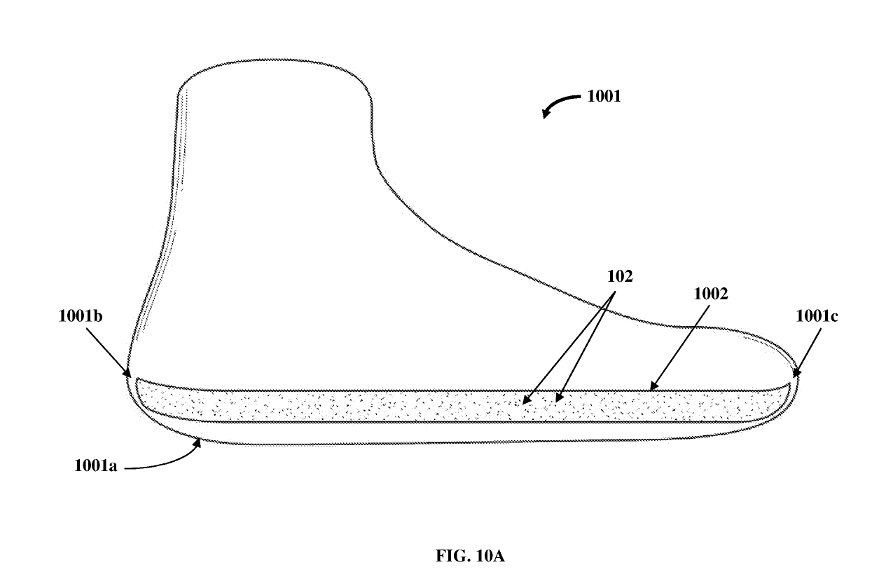

FIG. 10A exemplarily illustrates a bottom perspective view of an embodiment of the non-slip removable footwear insert configured as a bootie 1001. In this embodiment, the non-slip material 102 is configured as a single continuous strip 1002 and applied on a bottom surface 1001a of the bootie 1001. In an embodiment, the non-slip material 102 is configured as a single continuous strip 1002 and is applied to extend from the heel section 1001b to the toe section 1001c on an outer bottom surface 1001a of the bootie 1001 as exemplarily illustrated in FIG. 10A. This single continuous strip 1002 of the non-slip material 102 positioned and attached on the outer bottom surface 1001a of the bootie 1001 provides a gripping contact to a portion of the inner surface 104 of the shoe 103 exemplarily illustrated in FIGS. 1A-1B, that comes in contact with the single continuous strip 1002 of the non-slip material 102 on the outer bottom surface 1001a of the bootie 1001. In another embodiment (not shown), instead of the single continuous strip 1002 of non-slip material 102, the outer bottom surface 1001a of the bootie 1001 is coated with a non-slip material 102, for example, made from natural rubber, synthetic rubber, natural latex, thermoplastic rubber (TPR), thermoplastic elastomers (TPE), polyurethane, polyvinyl chloride, synthetic suede-like non-slip finishes, natural suede-like non-slip finishes, etc.

FIG. 10B exemplarily illustrates a cutaway sectional view of the embodiment of the non-slip removable footwear insert configured as a bootie 1001 shown in FIG. 10A. In this embodiment, the non-slip material 102 is configured as a single continuous strip 1003 extending from the heel section 1001b to the toe section 1001c on an inner bottom surface 1001d of the bootie 1001. The single continuous strip 1003 of the non-slip material 102 positioned and attached on the inner bottom surface 1001d of the bootie 1001 provides a gripping contact to the bottom surface 106a of the user's foot 106, for example, from the heel 106b to the toes 106d of the user's foot 106 exemplarily illustrated in FIG. 1B, that comes in contact with the single continuous strip 1003 of the non-slip material 102. In another embodiment as exemplarily illustrated in FIGS. 10A-10B, the single continuous strips 1002 and 1003 of the non-slip material 102 are positioned and attached on both the outer bottom surface 1001a of the bootie 1001 exemplarily illustrated in FIG. 10A, and the inner bottom surface 1001d of the bootie 1001 exemplarily illustrated in FIG. 10B, to provide simultaneous gripping contact to a portion of the inner surface 104 of the shoe 103 and the bottom surface 106a of the user's foot 106 respectively exemplarily illustrated in FIGS. 1A-1B, that come in contact with the single continuous strips 1002 and 1003 of the non-slip material 102 on the outer bottom surface 1001a and the inner bottom surface 1001d of the bootie 1001 respectively.

In another embodiment (not shown), the non-slip material 102 is configured as a single non-continuous strip (not shown) and applied to extend from the heel section 1001b to the toe section 1001c on the outer bottom surface 1001a of the bootie 1001 exemplarily illustrated in FIG. 10A. This single non-continuous strip of the non-slip material 102 positioned and attached on the outer bottom surface 1001a of the bootie 1001 provides a selective gripping contact to portions of the inner surface 104 of the shoe 103 that come in contact with the single non-continuous strip of the non-slip material 102. In another embodiment (not shown), the non-slip material 102 is configured as a single non-continuous strip (not shown) extending from the heel section 1001b to the toe section 1001c on the inner bottom surface 1001d of the bootie 1001 exemplarily illustrated in FIG. 10B. The single non-continuous strip of the non-slip material 102 positioned and attached on the inner bottom surface 1001d of the bootie 1001 provides a selective gripping contact to the bottom surface 106a of the user's foot 106, for example, from the heel 106b to the toes 106d of the user's foot 106 exemplarily illustrated in FIG. 1B, that comes in contact with the single non-continuous strip of the non-slip material 102 on the inner bottom surface 1001d of the bootie 1001. In another embodiment (not shown), the single non-continuous strips (not shown) of the non-slip material 102 are positioned on both the outer bottom surface 1001a and the inner bottom surface 1001d of the bootie 1001 to provide a simultaneous selective gripping contact to portions of the inner surface 104 of the shoe 103 and the bottom surface 106a of the user's foot 106 respectively, that come in contact with the single non-continuous strips of the non-slip material 102 on the outer bottom surface 1001a and the inner bottom surface 1001d of the bootie 1001. In another embodiment (not shown), the single non-continuous strip of the non-slip material 102 is configured, for example, as rectangular tabs spaced at equal intervals from the heel section 1001b to the toe section 1001c on the outer bottom surface 1001a of the bootie 1001, or on the inner bottom surface 1001d, or on both the outer bottom surface 1001a and the inner bottom surface 1001d of the bootie 1001. In another embodiment (not shown), the single non-continuous strip of the non-slip material 102 is configured to extend from an ankle section 1001e to the toe section 1001c on the inner bottom surface 1001a of the bootie 1001 to provide grip to the ankle 106c of the user's foot 106 exemplarily illustrated in FIG. 1B. The bootie 901 or 1001 exemplarily illustrated in FIGS. 9A-10B, is also referred to as a “non-slip removable sock liner”. The bootie 901 or 1001 extends upward from the heel 106b of the foot 106 and envelopes the upper surface 106f of the foot 106 exemplarily illustrated in FIG. 1B.

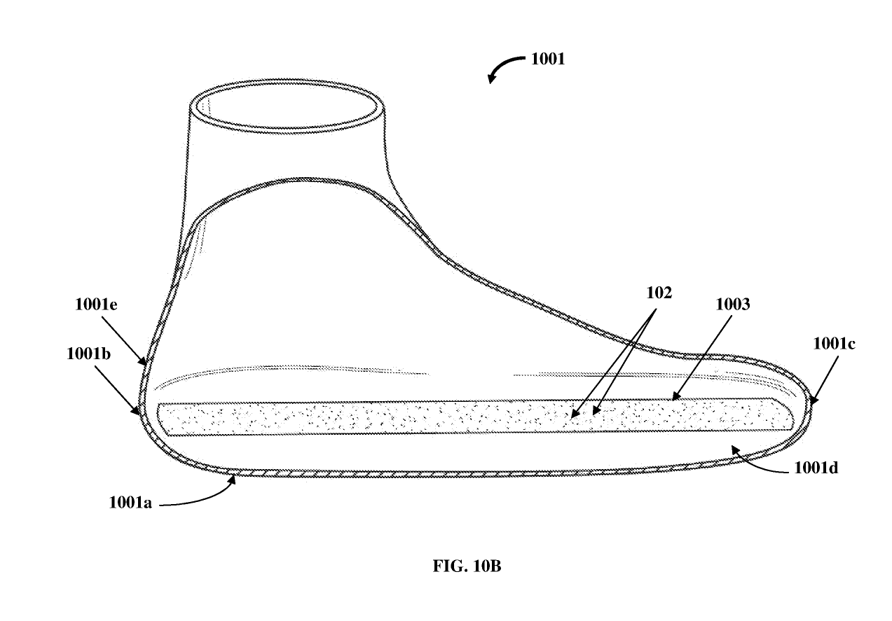

FIG. 11 exemplarily illustrates application of a non-slip material 102 on the insert member 101 to create the non-slip removable footwear insert 100, by pouring the non-slip material 102 on an entire upper surface 101a or a substantially entire upper surface 101a of the insert member 101. In an embodiment, the application of the non-slip material 102 to the whole portion or to the entire or substantially the entire lower surface 101b of the insert member 101 is performed by pouring the non-slip material 102 on the lower surface 101b of the insert member 101 through a nozzle 1101. After pouring the non-slip material 102 through the nozzle 1101, the non-slip material 102 adheres to the entire or substantially the entire lower surface 101b of the insert member 101. The non-slip material 102 then solidifies on the lower surface 101b of the insert member 101. The non-slip material 102 is also applied to the whole portion or the entire or substantially the entire upper surface 101a of the insert member 101 by pouring the non-slip material 102 on the entire or substantially the entire upper surface 101a of the insert member 101. After pouring the non-slip material 102 through the nozzle 1101, the non-slip material 102 adheres to the entire or substantially the entire upper surface 101a of the insert member 101. The non-slip material 102 then solidifies on the upper surface 101a of the insert member 101. In this embodiment, the non-slip material 102 is applied on both the upper surface 101a and the lower surface 101b of the insert member 101 by pouring the non-slip material 102 on both the upper surface 101a and the lower surface 101b of the insert member 101. That is, after pouring the non-slip material 102 on the entire or substantially the entire lower surface 101b of the insert member 101, the insert member 101 is flipped over prior to pouring the non-slip material 102 on the entire or substantially the entire upper surface 101a of the insert member 101 as exemplarily illustrated in FIG. 11. In another embodiment, the non-slip material 102 is applied only on the upper surface 101a of the insert member 101 by pouring the non-slip material 102 on only the upper surface 101a of the insert member 101. In another embodiment, the application of the non-slip material 102 on the insert member 101 is performed by pouring the non-slip material 102 on the upper surface 101a, or on the lower surface 101b, or on both the upper surface 101a and the lower surface 101b of the insert member 101 in one or more of multiple patterns.

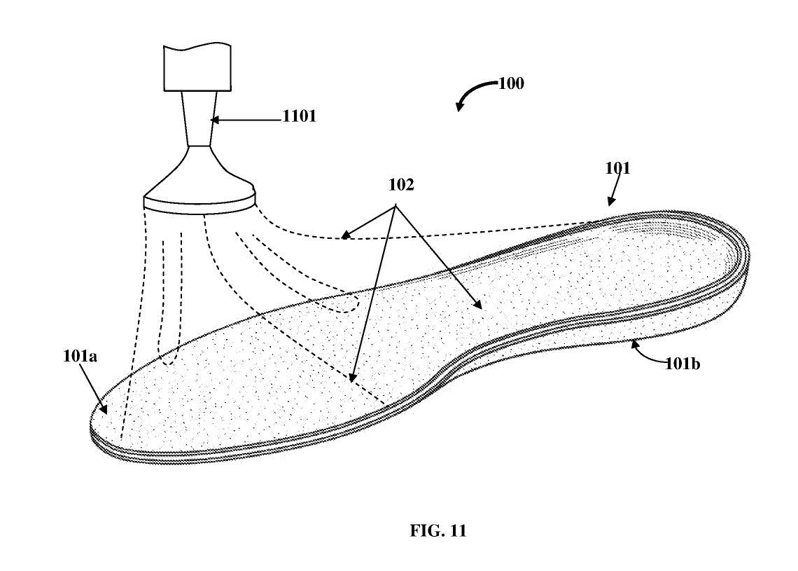

FIG. 12 exemplarily illustrates application of a non-slip material 102 on the insert member 101 to create the non-slip removable footwear insert 100, by spraying the non-slip material 102 on an entire upper surface 101a or a substantially entire upper surface 101a of the insert member 101. In an embodiment, the application of the non-slip material 102 to the whole portion or the entire or substantially the entire lower surface 101b of the insert member 101 is performed by spraying the non-slip material 102 on the entire or substantially the entire lower surface 101b of the insert member 101 through a nozzle 1201. After spraying the non-slip material 102 through the nozzle 1201, the non-slip material 102 adheres to the entire or substantially the entire lower surface 101b of the insert member 101. The non-slip material 102 then solidifies on the lower surface 101b of the insert member 101. The non-slip material 102 is also applied to the whole portion or the entire or substantially the entire upper surface 101a of the insert member 101 by spraying the non-slip material 102 on the entire or substantially the entire upper surface 101a of the insert member 101. After spraying the non-slip material 102 through the nozzle 1201, the sprayed non-slip material 102 adheres to the entire or substantially the entire upper surface 101a of the insert member 101. The non-slip material 102 then solidifies on the upper surface 101a of the insert member 101. In this embodiment, the non-slip material 102 is applied on both the upper surface 101a and the lower surface 101b of the insert member 101 by spraying the non-slip material 102 on both the upper surface 101a and the lower surface 101b of the insert member 101. That is, after spraying the non-slip material 102 on the entire or substantially the entire lower surface 101b of the insert member 101, the insert member 101 is flipped over prior to spraying the non-slip material 102 on the entire or substantially the entire upper surface 101a of the insert member 101 as exemplarily illustrated in FIG. 12. In another embodiment, the non-slip material 102 is applied only on the upper surface 101a of the insert member 101 by spraying the non-slip material 102 on only the upper surface 101a of the insert member 101. In another embodiment, the non-slip material 102 is selectively applied on the insert member 101 by spraying the non-slip material 102 on the upper surface 101a, or on the lower surface 101b, or on both the upper surface 101a and the lower surface 101b in one or more of multiple patterns.

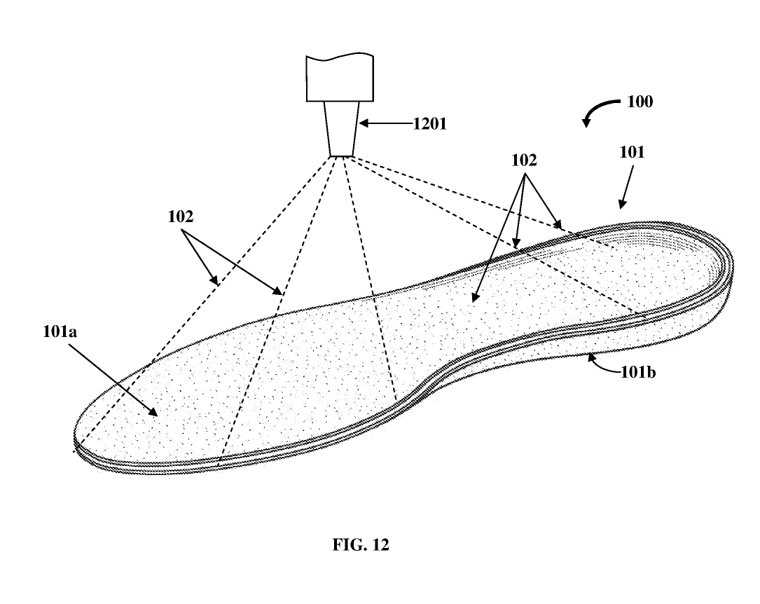

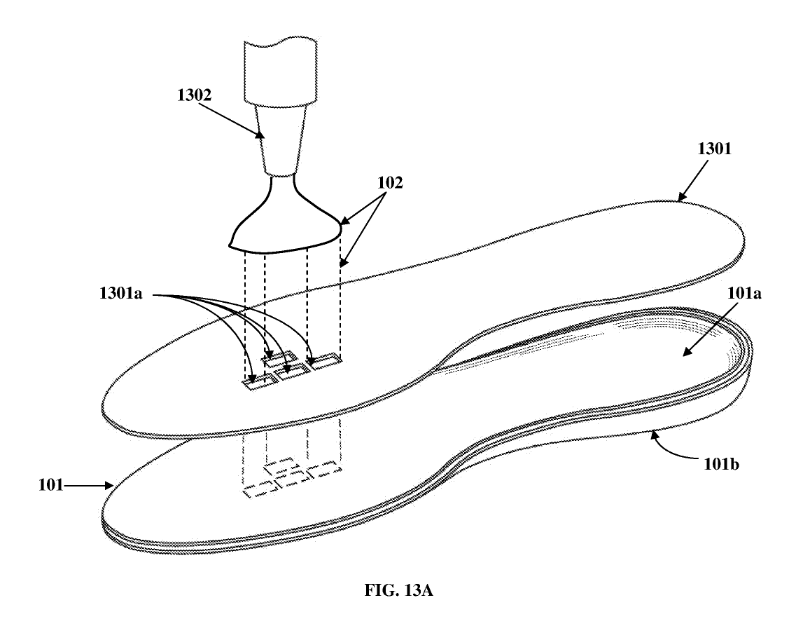

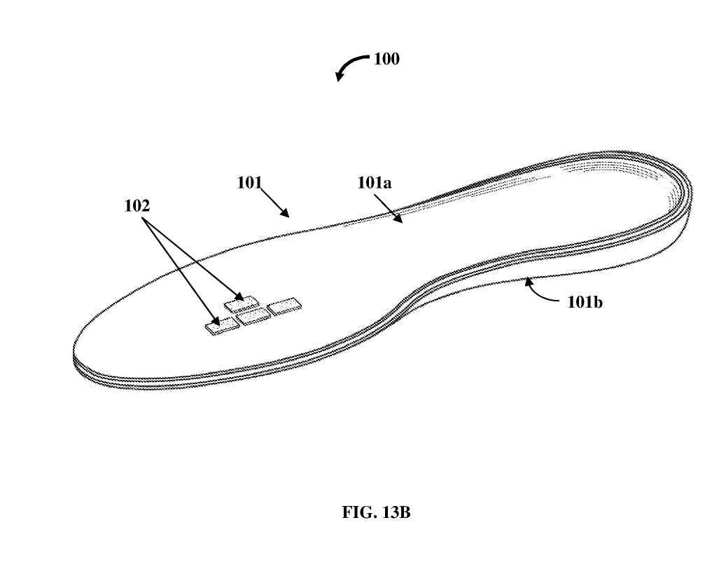

FIG. 13A exemplarily illustrates application of a non-slip material 102 on the insert member 101 to create the non-slip removable footwear insert 100 exemplarily illustrated in FIG. 13B, using a design frame 1301. In an embodiment for applying the non-slip material 102 to the insert member 101, a design frame 1301 comprising one or more patterned openings 1301a is provided. The design frame 1301 is, for example, a template, a stencil, a mask, a mold, a screen, etc. The design frame 1301 is positioned on the upper surface 101a, or on the lower surface 101b, or on both the upper surface 101a and the lower surface 101b of the insert member 101 to apply the non-slip material 102 on the upper surface 101a, or on the lower surface 101b, or on both the upper surface 101a and the lower surface 101b of the insert member 101.

As exemplarily illustrated in FIG. 13A, the non-slip material 102, for example, thermoplastic rubber that is in a liquid form obtained by mixing the thermoplastic rubber in a solution base, or by heating the thermoplastic rubber to a melting point, is applied or selectively applied on the design frame 1301 for application to the upper surface 101a of the insert member 101. The non-slip material 102 passes through the patterned openings 1301a of the design frame 1301 and adheres to the upper surface 101a of the insert member 101 in a pattern defined by the patterned openings 1301a of the design frame 1301. The application of the non-slip material 102 or the selective application of the non-slip material 102 on the design frame 1301 is performed, for example, by one or more of painting, pouring, screen printing, and spraying the non-slip material 102 on the design frame 1301 to allow the non-slip material 102 to pass through the patterned openings 1301a of the design frame 1301 and adhere to the upper surface 101a of the insert member 101 in the pattern defined by the patterned openings 1301a on the design frame 1301. The shapes of the patterned openings 1301a of the design frame 1301 and the arrangement of the patterned openings 1301a in the design frame 1301 define the shapes of the non-slip material 102 that adhere to the upper surface 101a of the insert member 101 and the pattern of the non-slip material 102 on the upper surface 101a of the insert member 101 as exemplarily illustrated in FIG. 13B. Design frames 1301 with patterned openings 1301a of any shape, for example, a square shape, a rectangular shape, a circular shape, etc., and any arrangement can be used for applying the non-slip material 102 to the insert member 101. Similarly, the non-slip material 102 is applied on the lower surface 101b of the insert member 101.

FIG. 13B exemplarily illustrates a top perspective view of the non-slip removable footwear insert 100, showing the non-slip material 102 configured, for example, as rectangular shapes on the insert member 101. The non-slip material 102 of different shapes and arranged in different patterns on the upper surface 101a and the lower surface 101b of the insert member 101 allows the insert member 101 to adhere, for example, to the bottom surface 106a of the user's foot 106 and the inner surface 104 of the shoe 103 exemplarily illustrated in FIG. 1B, respectively and simultaneously, thereby inhibiting slippage between the upper surface 101a of the insert member 101 and the bottom surface 106a of the foot 106, and also between the lower surface 101b of the insert member 101 and the inner surface 104 of the shoe 103.

Consider an example where the non-slip material 102, for example, in a semi-liquid form is poured through the patterned openings 1301a of the design frame 1301 positioned above the upper surface 101a of the insert member 101 using a nozzle 1302 as exemplarily illustrated in FIG. 13A. The non-slip material 102 passes through the patterned openings 1301a of the design frame 1301 and adheres to the upper surface 101a of the insert member 101 in a pattern defined by the patterned openings 1301a of the design frame 1301 as exemplarily illustrated in FIG. 13B. The non-slip material 102 then solidifies on the insert member 101. The insert member 101 is then flipped and repositioned prior to pouring the non-slip material 102 through the patterned openings 1301a of the design frame 1301 positioned above the lower surface 101b of the insert member 101. The non-slip material 102 passes through the patterned openings 1301a of the design frame 1301 and adheres to the lower surface 101b of the insert member 101 in a pattern defined by the patterned openings 1301a of the design frame 1301.

In another embodiment, the non-slip material 102 is applied or selectively applied on selective continuous portions or, in an embodiment, on selective non-continuous portions, or in another embodiment, on whole portions of the upper surface 101a, or the lower surface 101b, or both the upper surface 101a and the lower surface 101b of the insert member 101 directly without the design frame 1301, for example, by one or more of heat-gluing, heat pressing, pressure gluing, heat-sealing, spraying, pouring, painting, screen printing, and attaching or selectively attaching, for example, by sewing the non-slip material 102 on the selective continuous portions, or the selective non-continuous portions, or the whole portions of the upper surface 101a, or the lower surface 101b, or both the upper surface 101a and the lower surface 101b of the insert member 101. In an embodiment, the non-slip material 102 is applied on selective continuous portions or, in an embodiment, on selective non-continuous portions, or in another embodiment, on whole portions of the upper surface 101a and the lower surface 101b of the insert member 101 in one or more of multiple patterns.

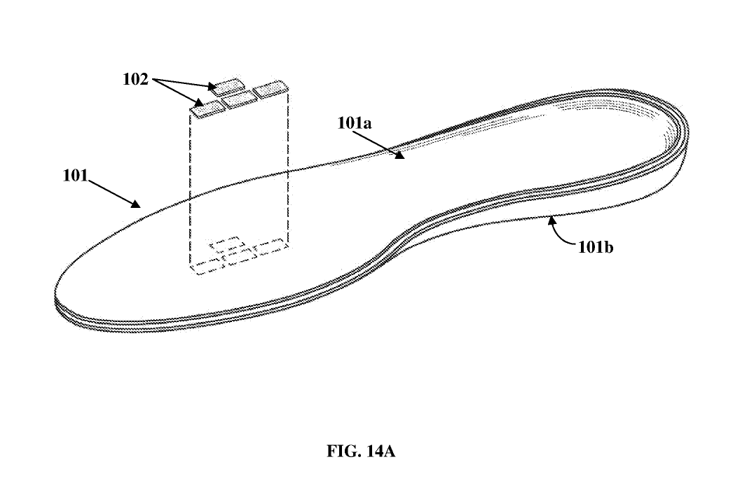

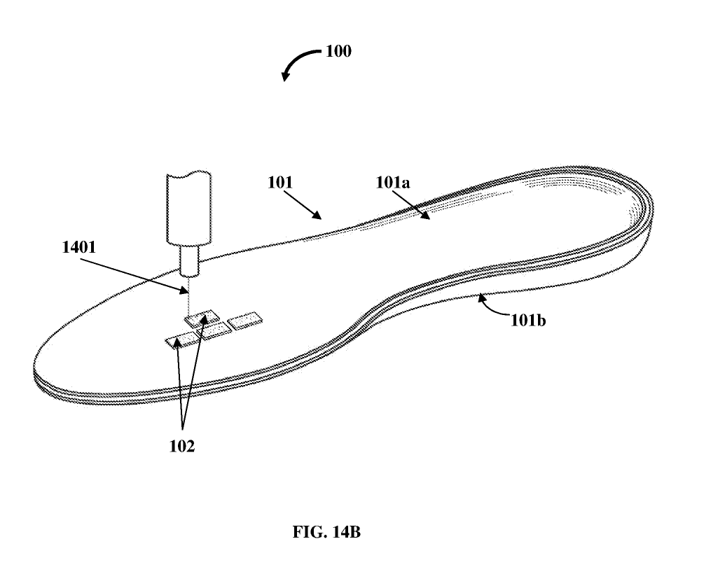

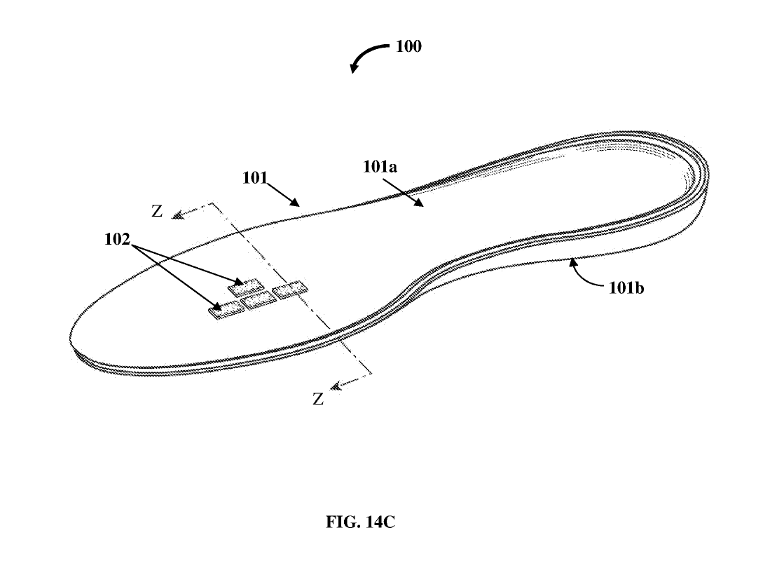

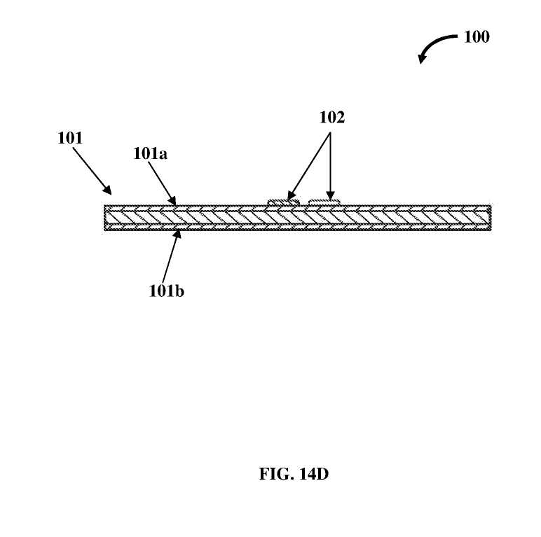

FIG. 14A exemplarily illustrates a top perspective view of an insert member 101 prior to sewing of rectangular shaped non-slip material 102 thereon to create the non-slip removable footwear insert 100 exemplarily illustrated in FIGS. 14B-14D. In an embodiment, the non-slip material 102 is configured into one or more of multiple shapes, for example, rectangular shapes, square shapes, circular shapes, etc., and applied continuously or non-continuously on the upper surface 101a, or on the lower surface 101b, or on both the upper surface 101a and the lower surface 101b of the insert member 101. For example, the non-slip material 102, for example, Clarino® blocks are applied or selectively applied on the upper surface 101a, or on the lower surface 101b, or on both the upper surface 101a and the lower surface 101b of the insert member 101 by sewing the non-slip material 102 on the upper surface 101a, or on the lower surface 101b, or on both the upper surface 101a and the lower surface 101b of the insert member 101. In an embodiment, the non-slip material 102 is applied continuously on the upper surface 101a, or on the lower surface 101b, or on both the upper surface 101a and the lower surface 101b of the insert member 101 by spacing the non-slip material 102 close to each other. In another embodiment, the non-slip material 102 is applied non-continuously on the upper surface 101a, or on the lower surface 101b, or on both the upper surface 101a and the lower surface 101b of the insert member 101 by spacing the non-slip material 102 apart from each other.

FIG. 14B exemplarily illustrates a top perspective view of the insert member 101, showing the rectangular shaped non-slip material 102 being sewn on the upper surface 101a of the insert member 101 to create the non-slip removable footwear insert 100. The non-slip material 102, for example, Clarino® blocks are disposed over the upper surface 101a of the insert member 101 and sewn on the upper surface 101a of the insert member 101 using a sewing needle 1401 as exemplarily illustrated in FIG. 14B. Similarly, the non-slip material 102 is sewn on the lower surface 101b of the insert member 101. In an embodiment, the non-slip material 102 is disposed over the insert member 101 in one or more of multiple patterns on the upper surface 101a and the lower surface 101b of the insert member 101 and sewn thereon to construct the non-slip removable footwear insert 100.

FIG. 14C exemplarily illustrates a top perspective view of the non-slip removable footwear insert 100, showing the rectangular shaped non-slip material 102 sewn on the upper surface 101a of the insert member 101. FIG. 14D exemplarily illustrates a sectional view of the non-slip removable footwear insert 100 taken along a sectional line Z-Z shown in FIG. 14C.

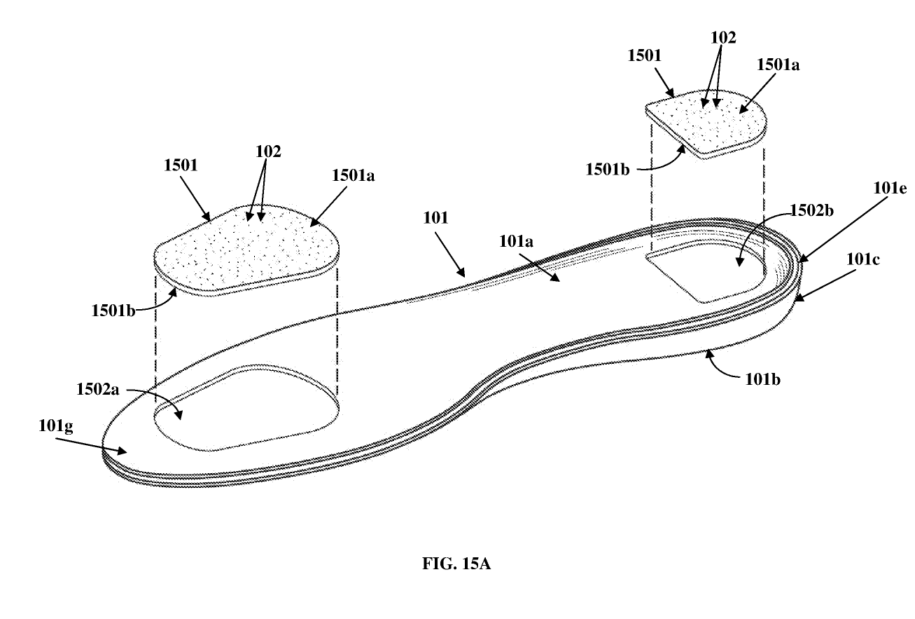

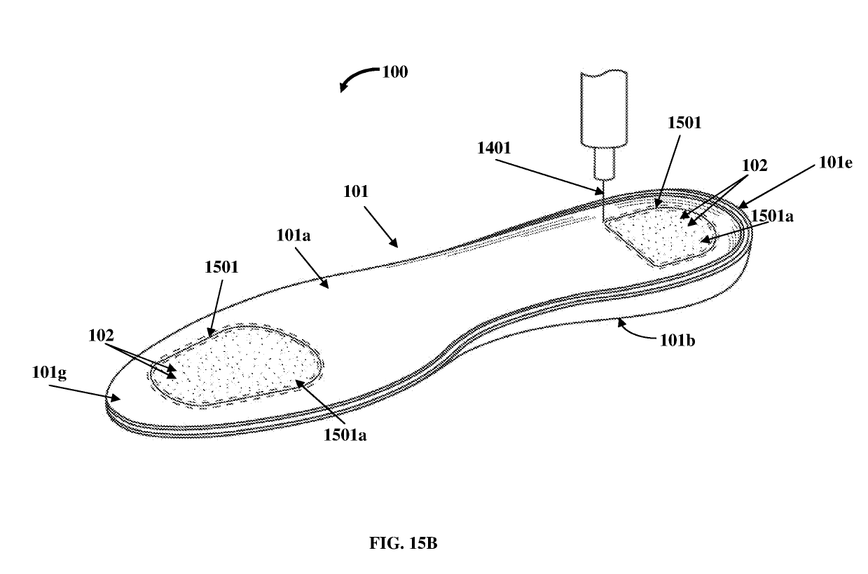

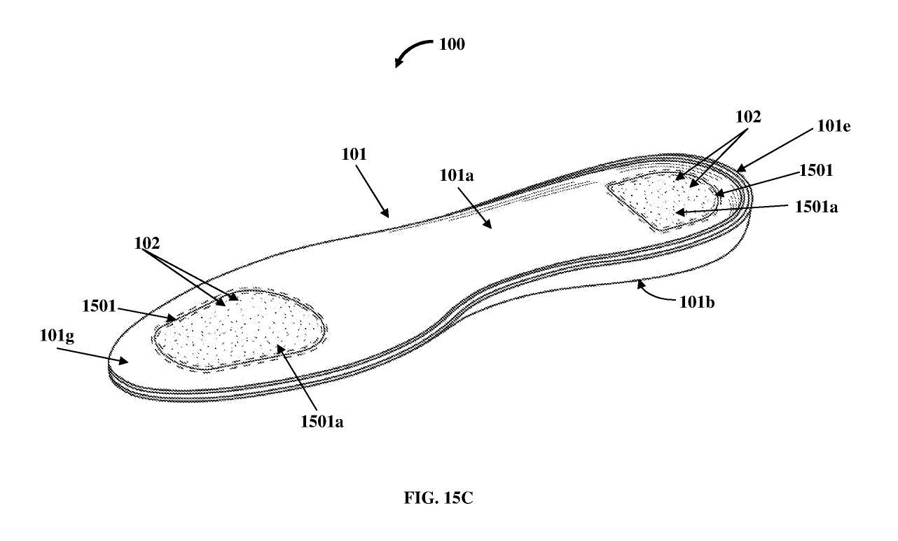

FIG. 15A exemplarily illustrates a top perspective view of an insert member 101 prior to application of patches 1501 of non-slip material 102 thereon to create the non-slip removable footwear insert 100 exemplarily illustrated in FIGS. 15B-15C. In an embodiment, the non-slip material 102 is configured as a patch 1501 having a non-slip upper surface 1501a and a non-slip lower surface 1501b. The patch 1501 is, for example, made of a non-slip material 102, for example, a thermoplastic elastomer, a polyvinyl chloride, natural latex, synthetic latex, synthetic suede, suede leather, synthetic leather, other leathers, etc. Patches 1501 exemplarily illustrated in FIG. 15A, are attached or selectively attached, for example, by sewing or bonding the patches 1501 to selective continuous portions or selective non-continuous portions of the upper surface 101a and the lower surface 101b of the insert member 101 for providing grip between the bottom surface 106a of the foot 106 exemplarily illustrated in FIG. 1B, and the insert member 101, and for providing grip between the insert member 101 and the inner surface 104 of the shoe 103 exemplarily illustrated in FIGS. 1A-1B. The attached or selectively attached patch 1501 contacts both the bottom surface 106a of the foot 106 and the inner surface 104 of the shoe 103 simultaneously.

As exemplarily illustrated in FIG. 15A, patches 1501 with non-slip material 102 on the upper surface 1501a and the lower surface 1501b are configured for attachment proximal to the periphery 101e of the heel section 101c and the toe section 101g of the insert member 101 to provide a selective grip to the heel 106b and the toes 106d of the user's foot 106 exemplarily illustrated in FIG. 1B, that come in contact with the patches 1501. In an embodiment, one or more openings 1502a and 1502b are created in the insert member 101. The patches 1501 having the non-slip surfaces 1501a and 1501b are configured to be sewn along edges of the openings 1502a and 1502b of the insert member 101.

FIG. 15B exemplarily illustrates a top perspective view of the insert member 101, showing the patches 1501 of non-slip material 102 being sewn on the upper surface 101a of the insert member 101 to create the non-slip removable footwear insert 100. The patches 1501 having non-slip surfaces 1501a and 1501b are targeted towards the openings 1502a and 1502b created in the insert member 101 exemplarily illustrated in FIG. 15A, and sewn along the edges of the openings 1502a and 1502b, for example, using a sewing needle 1401 as exemplarily illustrated in FIG. 15B, to cover the openings 1502a and 1502b in the insert member 101.

FIG. 15C exemplarily illustrates a top perspective view of the non-slip removable footwear insert 100, showing the patches 1501 of non-slip material 102 sewn on the upper surface 101a of the insert member 101. The sewn patches 1501 having the non-slip surfaces 1501a and 1501b, for example, proximal to the periphery 101e of the heel section 101c and the toe section 101g of the insert member 101 provide a selective grip, for example, to the heel 106b and the toes 106d of the user's foot 106 exemplarily illustrated in FIG. 1B, between the user's heel 106b and the toes 106d and the patches 1501 and simultaneously provide a selective grip, that is, traction between the patches 1501 and the inner surface 104 of the shoe 103 exemplarily illustrated in FIG. 1B, worn by the user.

In another embodiment, a non-slip material 102, for example, natural leather or synthetic leather, having an non-slip upper surface 1501a and a non-slip lower surface 1501b is attached or selectively attached, for example, by sewing, heat pressing, etc., to the selective continuous portions or the selective non-continuous portions of the upper surface 101a and the lower surface 101b of the insert member 101. The resulting non-slip removable footwear insert 100 will therefore have a smooth leather finish. In another embodiment, non-slip materials 102, for example, polyvinyl chloride, thermoplastic elastomers, natural latex rubber, Clarino®, etc., are applied or selectively applied, for example, by sewing, heat pressing, etc., to the selective continuous portions or selective non-continuous portions of the upper surface 101a and the lower surface 101b of the insert member 101 for providing non-slip properties, blister prevention properties, etc., to the insert member 101.

FIG. 16A exemplarily illustrates heat pressing of a non-slip material 102 on an entire upper surface 101a or a substantially entire upper surface 101a of an insert member 101 and on an entire lower surface 101b or a substantially entire lower surface 101b of the insert member 101 using a heat press 1601. In an embodiment, the application of sheets of non-slip material 102 on the entire or substantially the entire upper surface 101a of the insert member 101 and on the entire or substantially the entire lower surface 101b of the insert member 101 is performed, for example, by heat pressing for transferring the sheets of non-slip material 102 to the upper surface 101a and the lower surface 101b of the insert member 101.

The sheets of non-slip material 102 are cut, for example, by laser cutting, die cutting, rotary cutting, etc., to a required specification and aligned on transfer materials 1602, for example, made of paper. The sheets of non-slip material 102 are attached to the transfer materials 1602 using a temporary adhesive 1603 provided on the transfer materials 1602. The temporary adhesive 1603 holds the non-slip material 102 in place until the non-slip material 102 is heat pressed onto the insert member 101 by using the heat press 1601. In an embodiment, surfaces 102a and 102b of the sheets of non-slip material 102 are coated with a sealing element, for example, a polyurethane heat seal adhesive 1604 such as the Bemis 3218 adhesive film of the Bemis Company Inc., which is a fabric glue, a polyurethane heat seal, etc. Bemis 3218 is a fully reacted elastomeric film that remains flexible over a wide temperature range. Bemis 3218 is a general purpose adhesive that combines a low activation temperature with a substantially high viscosity at its softening point. The transfer materials 1602 that carry the sheets of non-slip material 102 are positioned above and below the insert member 101 as exemplarily illustrated in FIG. 16A, with the non-slip material 102 facing the upper surface 101a and the lower surface 101b of the insert member 101 respectively.

The transfer materials 1602 with the sheets of non-slip material 102 are positioned above and below the insert member 101. Heat at a predetermined temperature, for example, about 375 degrees Fahrenheit (F) and pressure is applied on the transfer materials 1602 that carry the sheets of non-slip material 102 above and below the insert member 101, for example, for about 20 seconds using the heat press 1601. The heat press 1601 compresses the sheets of non-slip material 102 towards the upper surface 101a and the lower surface 101b of the insert member 101, resulting in the transfer of the sheets of non-slip material 102 to the upper surface 101a and the lower surface 101b of the insert member 101. Due to the application of heat, the sheets of non-slip material 102 peel off from the transfer materials 1602 and permanently bond to the upper surface 101a and the lower surface 101b of the insert member 101, thereby creating continuous non-slip layers 1605a and 1605b on the upper surface 101a and the lower surface 101b of the insert member 101 respectively. As used herein, “continuous non-slip layer” refers to a continuous or substantially continuous surface or layer that is covered with the non-slip material 102. The transfer materials 1602 are thereafter removed from the insert member 101.

FIG. 16B exemplarily illustrates heat pressing of a non-slip material 102 configured into predefined shapes, for example, square shapes, rectangular shapes, etc., in contact with each other on the upper surface 101a and the lower surface 101b of the insert member 101 using a heat press 1601. In an embodiment, the creation of continuous non-slip layers 1605a and 1605b on the upper surface 101a and the lower surface 101b of the insert member 101 respectively, comprises configuring a sheet of non-slip material 102 into one or more shapes, for example, square shapes such as Clarino® blocks and applying the configured non-slip material 102 in those shapes continuously in contact with each other on selective continuous portions on the upper surface 101a and the lower surface 101b of the insert member 101. In this embodiment, the application of the configured non-slip material 102 on the upper surface 101a and the lower surface 101b of the insert member 101 is performed, for example, by heat pressing for transferring the configured non-slip material 102 to the upper surface 101a and the lower surface 101b of the insert member 101.

In an embodiment, the non-slip material 102 is cut, for example, by laser cutting, die cutting, rotary cutting, etc., for example, into square shapes to a required specification and aligned on transfer materials 1602, for example, made of paper. The configured non-slip material 102, for example, Clarino® blocks are positioned in contact with each other and attached to the transfer materials 1602 using a temporary adhesive 1603 provided on the transfer materials 1602. The temporary adhesive 1603 holds the configured non-slip material 102 in place until the configured non-slip material 102 is heat pressed onto the insert member 101 by using the heat press 1601. The transfer materials 1602 that carry the configured non-slip material 102 are positioned above and below the insert member 101 as exemplarily illustrated in FIG. 16B, with the configured non-slip material 102 facing the upper surface 101a and the lower surface 101b of the insert member 101 respectively. Surfaces 102a and 102b of the configured non-slip material 102 are coated with a sealing element, for example, a heat seal adhesive 1604 such as Bemis 3218, fabric glue, a polyurethane heat seal, etc.

The configured non-slip material 102 is applied on the upper surface 101a and the lower surface 101b of the insert member 101 by heat pressing as disclosed in the detailed description of FIG. 16A. The heat seal adhesive 1604 attaches the configured non-slip material 102 to the upper surface 101a and the lower surface 101b of the insert member 101. After the configured non-slip material 102 is transferred to the upper surface 101a and the lower surface 101b of the insert member 101, the transfer materials 1602 are peeled off from the insert member 101, while retaining the configured non-slip material 102 on the insert member 101 to create continuous non-slip layers 1605a and 1605b on the upper surface 101a and the lower surface 101b of the insert member 101 respectively.

FIG. 16C exemplarily illustrates heat pressing of a non-slip material 102 configured into predefined shapes, for example, square shapes, rectangular shapes, etc., spaced apart from each other on the upper surface 101a and the lower surface 101b of the insert member 101 using a heat press 1601. In an embodiment, the creation of non-continuous non-slip layers 1605a and 1605b on the upper surface 101a and the lower surface 101b of the insert member 101 respectively, comprises configuring the non-slip material 102 into one or more shapes, for example, square shapes, rectangular shapes, etc., and applying the configured non-slip material 102 in one or more shapes spaced apart from each other on the selective non-continuous portions of the upper surface 101a and the lower surface 101b of the insert member 101, for example, by heat pressing as exemplarily illustrated in FIG. 16C. By performing heat pressing as disclosed in the detailed description of FIGS. 16A-16B, a sealing element, for example, a heat seal adhesive 1604 attaches the configured non-slip material 102 to the upper surface 101a and the lower surface 101b of the insert member 101. The insert member 101 with the applied non-slip material 102 on the selective non-continuous portions of the upper surface 101a and the lower surface 101b of the insert member 101 forms the non-slip removable footwear insert 100. The attached non-slip material 102 on the upper surface 101a and the lower surface 101b of the insert member 101 adheres to the user's foot 106 and the inner surface 104 of the shoe 103 respectively exemplarily illustrated in FIG. 1B, provides grip between the bottom surface 106a of the user's foot 106 and the insert member 101, and provides grip between the insert member 101 and the inner surface 104 of the shoe 103.

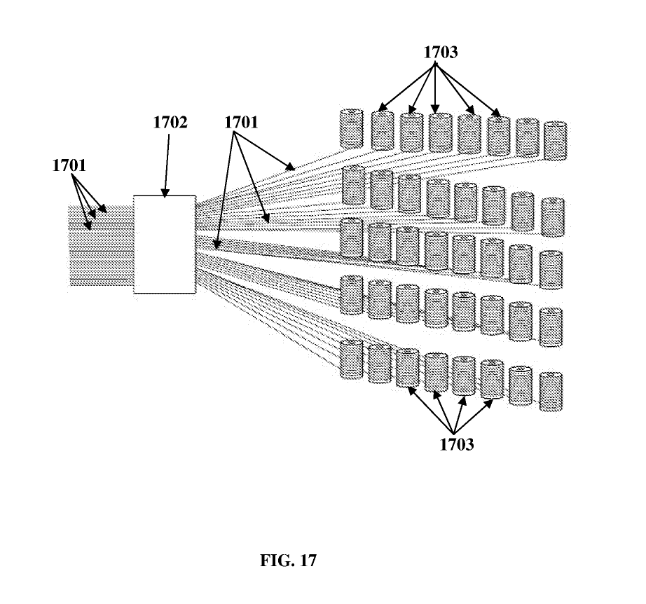

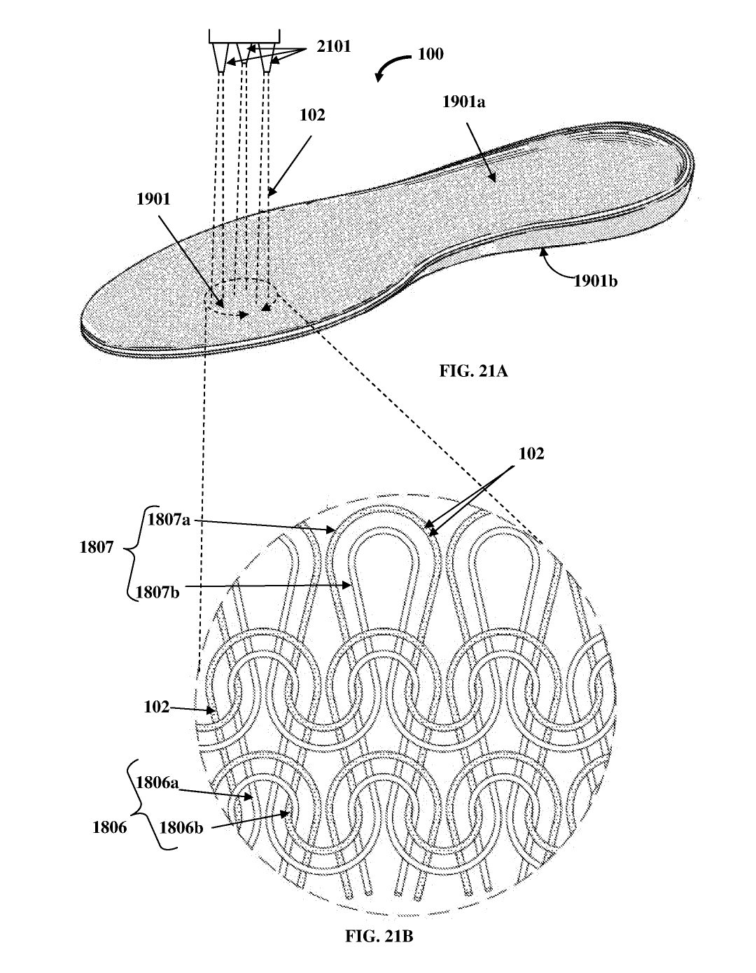

FIG. 17 exemplarily illustrates multiple threads 1701 being separated and wound around spools 1703 for creating a knitted insert member 1901 exemplarily illustrated in FIG. 19A. The threads 1701 are separated into and wound around separate spools 1703 using a twisting machine 1702. The threads 1701 comprise non-slip threads and supplementary threads. As used herein, “non-slip threads” refer to gripping, sticky, tacky, and/or textured threads that exhibit a generally high surface adhesion and provide grip between the bottom surface 106a of a user's foot 106 exemplarily illustrated in FIG. 1B, and a non-slip upper surface 1901a of the knitted insert member 1901 made from the non-slip threads, and simultaneously provide grip between a non-slip lower surface 1901b of the knitted insert member 1901 and an inner surface 104 of a shoe 103 exemplarily illustrated in FIGS. 1A-1B, worn by the user. In an embodiment, the non-slip threads are made by applying or selectively applying a non-slip material 102 exemplarily illustrated in FIG. 21A, to natural threads and/or synthetic threads, for example, by spraying, painting, pouring, etc., the non-slip material 102 on the natural threads and/or the synthetic threads. Also, as used herein, “supplementary threads” refer to threads made from a conventional material, for example, cotton, nylon, polyester, wool, etc. In an embodiment, the insert member 1901 is constructed by knitting non-slip threads with supplementary threads to define the non-slip upper surface 1901a and the non-slip lower surface 1901b for the insert member 1901.

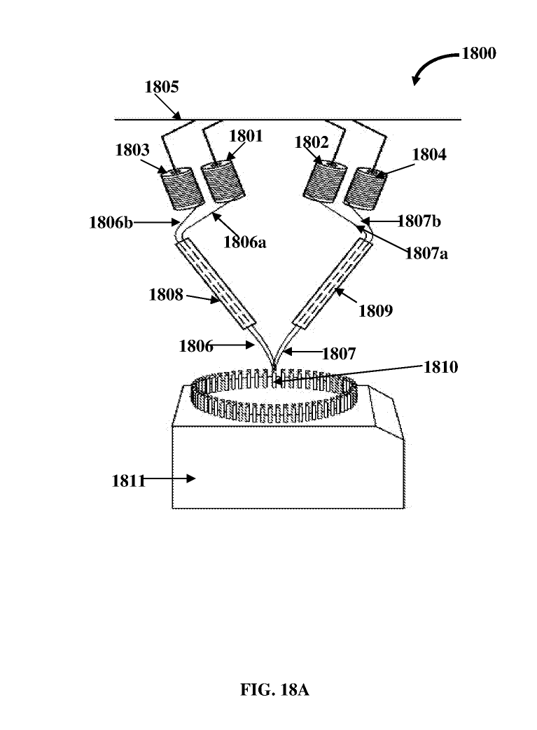

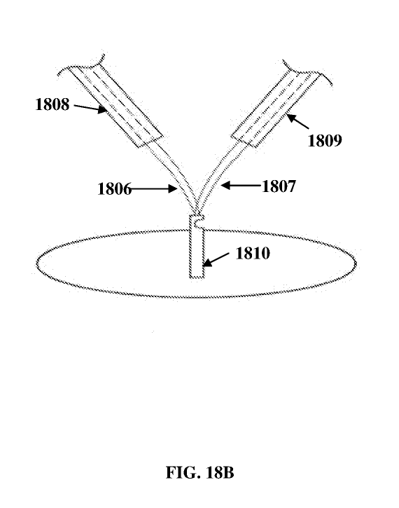

FIG. 18A exemplarily illustrates knitting of a first pair 1806 comprising a first non-slip thread 1806a and a first supplementary thread 1806b with a second pair 1807 comprising a second non-slip thread 1807a and a second supplementary thread 1807b for creating the knitted insert member 1901 exemplarily illustrated in FIGS. 19A-19B. The supplementary threads 1806b and 1807b are knitted along with the non-slip threads 1806a and 1807a respectively, to create the first pair 1806 and the second pair 1807 respectively. The first pair 1806 defines the non-slip upper surface 1901a of the knitted insert member 1901 exemplarily illustrated in FIGS. 19A-19B. The second pair 1807 defines the non-slip lower surface 1901b of the knitted insert member 1901 exemplarily illustrated in FIGS. 19A-19B. The non-slip threads 1806a and 1807a used for creating the knitted insert member 1901 are made from non-slip materials 102, tacky materials, and/or textured materials comprising, for example, one or more of synthetic rubber, natural latex, polyvinyl chloride, plastisol, thermoplastic rubber, thermoplastic elastomers, polyurethane, thermoplastic coatings on conventional threads, etc. The non-slip threads 1806a and 1807a are coated, for example, with silicon, talcum powder, etc., to prevent gathering and tangling during creation of the knitted insert member 1901. The supplementary threads 1806b and 1807b are selected from materials comprising, for example, cotton, nylon, polyester, or spandex such as Lycra® of E. I. du Pont de Nemours and Company, wool, acrylic, etc. The gauge of the first non-slip thread 1806a and the second non-slip thread 1807a is, for example, in the range of about 0.3 millimeter diameter to about 1 millimeter diameter.

The non-slip threads 1806a and 1807a are separated out of a box into first non-slip threads 1806a and second non-slip threads 1807a. Consider an example where a first non-slip thread 1806a, a second non-slip thread 1807a, a first supplementary thread 1806b, and a second supplementary thread 1807b are wound onto a first spool 1801, a second spool 1802, a third spool 1803, and a fourth spool 1804 respectively. The first spool 1801 of the first non-slip thread 1806a and the third spool 1803 of the first supplementary thread 1806b are placed onto a rack 1805 positioned on a knitting unit 1800, above a first finger tube 1808 as exemplarily illustrated in FIG. 18A. The second spool 1802 of the second non-slip thread 1807a and the fourth spool 1804 of the second supplementary thread 1807b are placed onto the rack 1805 positioned on the knitting unit 1800, above a second finger tube 1809 as exemplarily illustrated in FIG. 18A.

To create the non-slip upper surface 1901a of the knitted insert member 1901, the first non-slip thread 1806a and the first supplementary thread 1806b from the first spool 1801 and the third spool 1803 respectively, are simultaneously fed into the first finger tube 1808 as exemplarily illustrated in FIG. 18A. The first non-slip thread 1806a and the first supplementary thread 1806b are grouped into a first pair 1806 that defines the non-slip upper surface 1901a of the knitted insert member 1901. To create the non-slip lower surface 1901b of the knitted insert member 1901, the second non-slip thread 1807a and the second supplementary thread 1807b from the second spool 1802 and the fourth spool 1804 respectively, are fed simultaneously into the second finger tube 1809 as exemplarily illustrated in FIG. 18A. The second non-slip thread 1807a and the second supplementary thread 1807b are grouped into a second pair 1807 that defines the non-slip lower surface 1901b of the knitted insert member 1901.

The first pair 1806 and the second pair 1807 are retrieved from the first finger tube 1808 and the second finger tube 1809 respectively and knitted, for example, using a latch needle 1810 of a knitting machine 1811 exemplarily illustrated in FIGS. 18A-18B, for creating the knitted insert member 1901 exemplarily illustrated in FIG. 19A. The knitting machine 1811 is, for example, a Lonati 454 machine, Lonati Co., Brescia, Italy. The first pair 1806 is knitted with the second pair 1807 to form the knitted insert member 1901 using one or more of multiple latch needles 1810 in the circular knitting machine 1811 as exemplarily illustrated in FIG. 18A. The technique for knitting one or more pairs 1806 of threads 1806a and 1806b to define the non-slip upper surface 1901a of the knitted insert member 1901 and one or more pairs 1807 of the same or different material threads 1807a and 1807b to define the non-slip lower surface 1901b of the knitted insert member 1901 is known as plating. The first non-slip thread 1806a of the first pair 1806 is exposed on the upper surface 1901a of the knitted insert member 1901. The first non-slip thread 1806a of the first pair 1806 is not exposed on the lower surface 1901b of the knitted insert member 1901. The second non-slip thread 1807a of the second pair 1807 is exposed on the lower surface 1901b of the knitted insert member 1901. The second non-slip thread 1807a of the second pair 1807 is not exposed on the upper surface 1901a of the knitted insert member 1901.

In an embodiment, the knitted insert member 1901 comprising the non-slip upper surface 1901a and the non-slip lower surface 1901b is created by feeding the first non-slip thread 1806a, the second non-slip thread 1807a, the first supplementary thread 1806b, and the second supplementary thread 1807b into a first finger tube 1808, a second finger tube 1809, a third finger tube (not shown), and a fourth finger tube (not shown) respectively. A plating technique is used, for example, to knit the first supplementary thread 1806b retrieved from the third finger tube and the second supplementary thread 1807b retrieved from the fourth finger tube. The first supplementary thread 1806b is exposed on the upper surface 1901a of the knitted insert member 1901. The second supplementary thread 1807b is exposed on the lower surface 1901b of the knitted insert member 1901. The plating technique is also used to knit the first non-slip thread 1806a retrieved from the first finger tube 1808 and the second non-slip thread 1807a retrieved from the second finger tube 1809. The first non-slip thread 1806a is exposed on the upper surface 1901a of the knitted insert member 1901. The first non-slip thread 1806a is not exposed on the lower surface 1901b of the knitted insert member 1901. The second non-slip thread 1807a is exposed on the lower surface 1901b of the knitted insert member 1901. The second non-slip thread 1807a is not exposed on the upper surface 1901a of the knitted insert member 1901.

FIG. 18B exemplarily illustrates knitting the first pair 1806 and the second pair 1807 using a latch needle 1810 for creating the knitted insert member 1901 exemplarily illustrated in FIG. 19A. The latch needle 1810 receives the first pair 1806 of threads 1806a and 1806b and the second pair 1807 of threads 1807a and 1807b at the same time to form the non-slip upper surface 1901a and the non-slip lower surface 1901b of the knitted insert member 1901 simultaneously.

FIG. 19A exemplarily illustrates a top perspective view of a knitted insert member 1901. The knitted insert member 1901 comprises a non-slip upper surface 1901a and a non-slip lower surface 1901b.

FIG. 19B exemplarily illustrates an enlarged view of a portion of the knitted insert member 1901 shown in FIG. 19A. The non-slip upper surface 1901a of the knitted insert member 1901 is defined by a first pair 1806 comprising a first non-slip thread 1806a and a first supplementary thread 1806b, and the non-slip lower surface 1901b of the knitted insert member 1901 is defined by a second pair 1807 comprising a second non-slip thread 1807a and a second supplementary thread 1807b as exemplarily illustrated in FIG. 19B. In an embodiment, the knitted insert member 1901 is created without the use of a conventional supplementary thread, for example, by knitting only non-slip threads 1806a and 1807a to define the entire non-slip upper surface 1901a and the entire non-slip lower surface 1901b of the knitted insert member 1901. In this embodiment, the non-slip threads 1806a and 1807a are used exclusively to create the non-slip upper surface 1901a and the non-slip lower surface 1901b of the knitted insert member 1901. In another embodiment, the knitted insert member 1901 comprises one or more non-slip threads 1806a and 1807a in selective continuous portions, for example, a heel section 1901c and the toe section 1901d of the knitted insert member 1901.

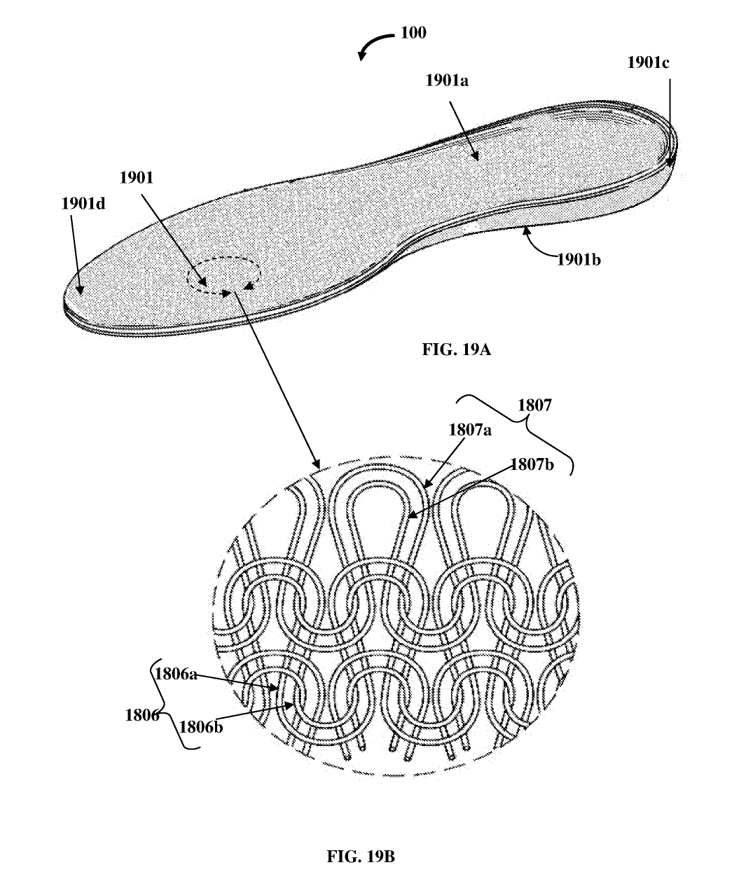

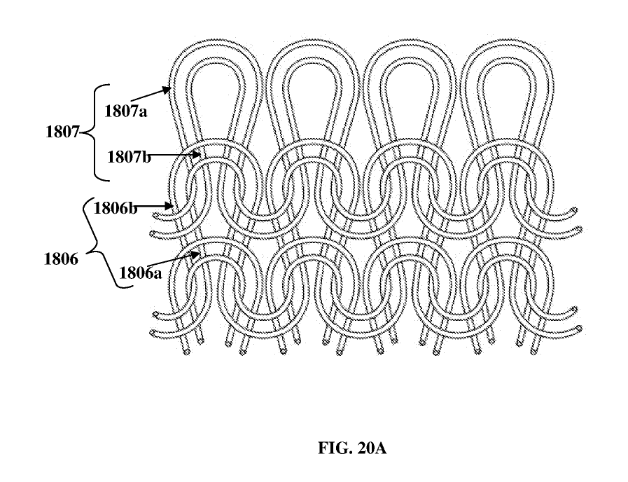

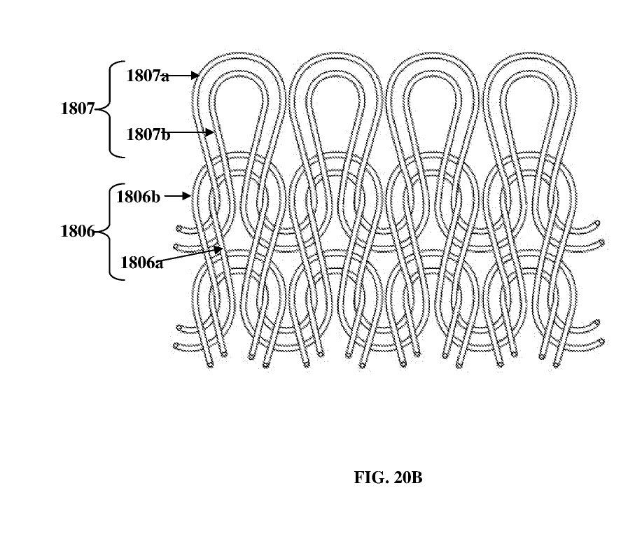

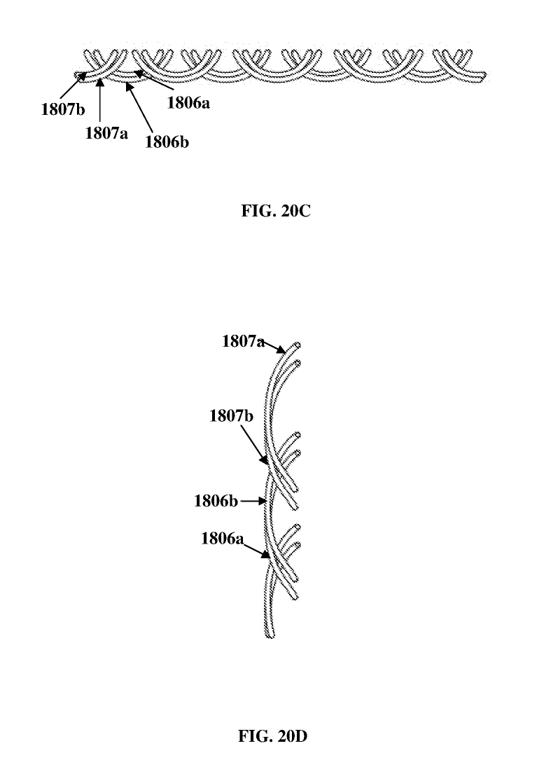

FIGS. 20A-20D exemplarily illustrate multiple views of the knitted insert member 1901 shown in FIG. 19A, showing a first pair 1806 comprising a first non-slip thread 1806a and a first supplementary thread 1806b knitted with a second pair 1807 comprising a second non-slip thread 1807a and a second supplementary thread 1807b. A bottom elevation view, a top view, and side views of the first pair 1806 comprising the first non-slip thread 1806a and the first supplementary thread 1806b knitted with the second pair 1807 comprising the second non-slip thread 1807a and the second supplementary thread 1807b are exemplarily illustrated in FIG. 20A, FIG. 20B, and FIGS. 20C-20D respectively. The knitted insert member 1901 is made of traction, non-slip yarns herein referred to as a first non-slip thread 1806a and a second non-slip thread 1807a, knitted with yarns made of a conventional material herein referred to as supplementary threads 1806b and 1807b. The first non-slip thread 1806a and the second non-slip thread 1807a are made of the same material. In an embodiment, the first non-slip thread 1806a and the second non-slip thread 1807a are made of different traction, non-slip materials. The first non-slip thread 1806a and the second non-slip thread 1807a are, for example, made of a synthetic material such as a synthetic rubber, or a natural material such as latex also known as natural rubber, or yarns coated with natural latex, polyvinyl chloride, thermoplastic rubber or thermoplastic elastomers, polyurethane, etc. In an embodiment, the non-slip threads 1806a and 1807a are extruded vulcanized natural latex, gauge 68 and 75, made by the following company: Heveafil Sdn. Bhd., No. 1, Jalan Heveafil, 44300 Batang Kali, Ulu Selangor, Selangor Darul Ehsan, Malaysia.

The supplementary threads 1806b and 1807b are made, for example, of materials such as cotton, nylon, Lycra®, acrylic, wool or other conventional materials used in the manufacture of, for example, socks, gloves, etc. In an embodiment, the knitted insert member 1901 comprises a first type of supplementary thread 1806b used to define the non-slip upper surface 1901a of the knitted insert member 1901 and a second type of supplementary thread 1807b used to define the non-slip lower surface 1901b of the knitted insert member 1901. For example, the first supplementary thread 1806b used to define the non-slip upper surface 1901a of the knitted insert member 1901, that accompanies the first non-slip thread 1806a, is made of cotton, while the second supplementary thread 1807b used to define the non-slip lower surface 1901b of the knitted insert member 1901, that accompanies the second non-slip thread 1807a is made of nylon. In an embodiment, the supplementary threads 1806b and 1807b used for the non-slip upper surface 1901a and the non-slip lower surface 1901b of the knitted insert member 1901 are made of the same material.

For purposes of illustration, the detailed description of FIGS. 18A-20D refers to the creation of the knitted insert member 1901 by knitting a first pair 1806 comprising a first non-slip thread 1806a and a first supplementary thread 1806b, and a second pair 1807 comprising a second non-slip thread 1807a and a second supplementary thread 1807b. However, the scope of the method disclosed herein is not limited to the first pair 1806 and the second pair 1807 but may be extended to include multiple pairs of multiple threads 1701 exemplarily illustrated in FIG. 17. In an embodiment, the first pair 1806 of threads 1806a and 1806b and the second pair 1807 of threads 1807a and 1807b are knitted to create the knitted insert member 1901 such that the non-slip upper surface 1901a of the knitted insert member 1901 and the non-slip lower surface 1901b of the knitted insert member 1901 are made of threads of the same non-slip material-supplementary material. In an embodiment, different non-slip material-supplementary material thread combinations are used for creation of the knitted insert member 1901.

FIG. 21A exemplarily illustrates application of a non-slip material 102 on a knitted insert member 1901 to create a non-slip removable footwear insert 100 by spraying a non-slip material 102 on the knitted insert member 1901. In an embodiment, the non-slip material 102, for example, in a liquid form is sprayed through nozzles 2101 on the non-slip lower surface 1901b of the knitted insert member 1901. After spraying the non-slip material 102 on the non-slip lower surface 1901b of the knitted insert member 1901, the knitted insert member 1901 is flipped upside down. The non-slip material 102 is then sprayed on the non-slip upper surface 1901a of the knitted insert member 1901 through the nozzles 2101 as exemplarily illustrated in FIG. 21A.

FIG. 21B exemplarily illustrates an enlarged view of a sprayed portion of the knitted insert member 1901 shown in FIG. 21A. In an embodiment, the non-slip material 102 is applied on the first non-slip thread 1806a and/or the first supplementary thread 1806b in the first pair 1806 that defines the non-slip upper surface 1901a of the knitted insert member 1901, and on the second non-slip thread 1807a and/or the second supplementary thread 1807b in the second pair 1807 that defines the non-slip lower surface 1901b of the knitted insert member 1901, for example, by spraying the non-slip material 102 on the non-slip upper surface 1901a and/or the non-slip lower surface 1901b of the knitted insert member 1901. In an embodiment, the non-slip material 102 is applied on the first non-slip thread 1806a and/or the first supplementary thread 1806b in the first pair 1806 that defines the non-slip upper surface 1901a of the knitted insert member 1901, and on the second non-slip thread 1807a and/or the second supplementary thread 1807b in the second pair 1807 that defines the non-slip lower surface 1901b of the knitted insert member 1901, for example, by spraying the non-slip material 102 on selective continuous portions or selective non-continuous portions of the non-slip upper surface 1901a and the non-slip lower surface 1901b of the knitted insert member 1901 in one or more patterns. As exemplarily illustrated in FIG. 21B, the non-slip material 102 adheres to the first supplementary thread 1806b in the first pair 1806 and to the second non-slip thread 1807a in the second pair 1807. The non-slip material 102 on the non-slip upper surface 1901a defined by the first pair 1806 and the non-slip lower surface 1901b defined by the second pair 1807 adheres to the user's foot 106 and the inner surface 104 of the shoe 103 exemplarily illustrated in FIG. 1B respectively, for providing enhanced grip between the user's foot 106 and the knitted insert member 1901, and between the knitted insert member 1901 and the inner surface 104 of the shoe 103 respectively.

In another embodiment, the non-slip material 102 is applied on the first non-slip thread 1806a and/or the first supplementary thread 1806b in the first pair 1806 that defines the non-slip upper surface 1901a of the knitted insert member 1901, and on the second non-slip thread 1807a and/or the second supplementary thread 1807b in the second pair 1807 that defines the non-slip lower surface 1901b of the knitted insert member 1901 exemplarily illustrated in FIG. 19B, for example, by one or more of painting, pouring, screen printing, etc., the non-slip material 102 on selective continuous portions or selective non-continuous portions of the non-slip upper surface 1901a and the non-slip lower surface 1901b of the knitted insert member 1901 in one or more patterns. In an embodiment, the non-slip material 102 is selectively applied on the first non-slip thread 1806a and/or the first supplementary thread 1806b in the first pair 1806 that defines the non-slip upper surface 1901a of the knitted insert member 1901, and on the second non-slip thread 1807a and/or the second supplementary thread 1807b in the second pair 1807 that defines the non-slip lower surface 1901b of the knitted insert member 1901 as exemplarily illustrated in FIG. 21A. For example, the non-slip material 102 can be added or coated to the first non-slip thread 1806a and/or the first supplementary thread 1806b in the first pair 1806, or on the second non-slip thread 1807a and/or the second supplementary thread 1807b in the second pair 1807 at 1/16^{th} of an inch intervals rather than coating the entire length of the threads 1806a, 1806b, 1807a, and 1807b on the spools 1801, 1803, 1802, and 1804 respectively, exemplarily illustrated in FIG. 18A.

In another embodiment, the non-slip material 102 can be added to or coated on the entire length of the first non-slip thread 1806a and/or the first supplementary thread 1806b in the first pair 1806, or on the second non-slip thread 1807a and/or the second supplementary thread 1807b in the second pair 1807. The non-slip material 102 adheres to the first non-slip thread 1806a and/or the first supplementary thread 1806b in the first pair 1806 and to the second non-slip thread 1807a and/or the second supplementary thread 1807b in the second pair 1807. The non-slip material 102 on the non-slip upper surface 1901a defined by the first pair 1806 and the non-slip lower surface 1901b defined by the second pair 1807 adheres to the user's foot 106 and the inner surface 104 of the shoe 103 exemplarily illustrated in FIG. 1B, respectively, for providing enhanced grip between the user's foot 106 and the knitted insert member 1901, and between the knitted insert member 1901 and the inner surface 104 of the shoe 103 respectively.

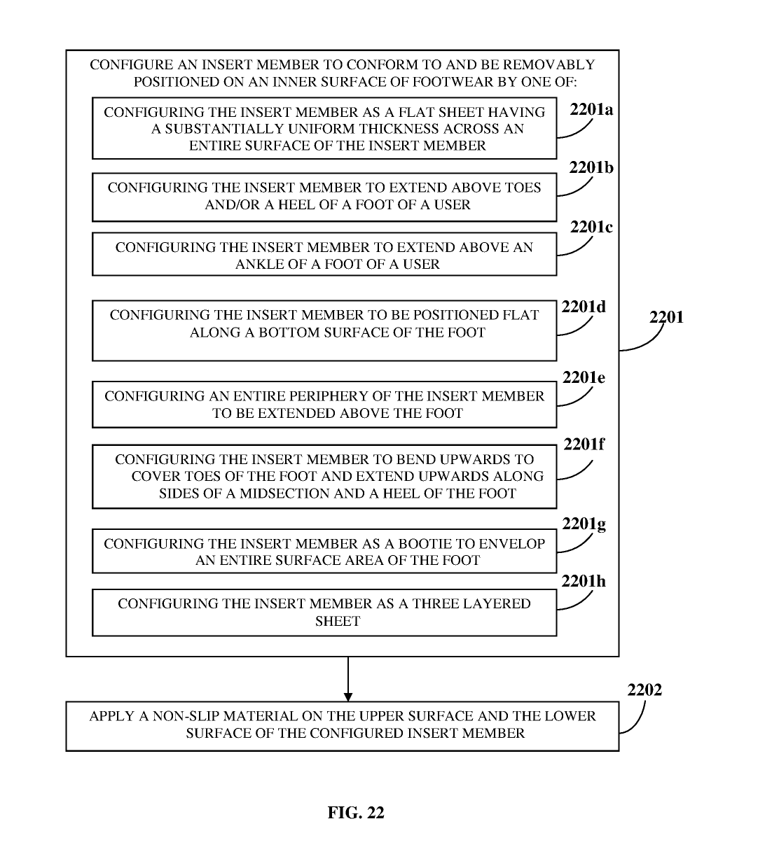

FIG. 22 illustrates a method for making a non-slip removable footwear insert 100 exemplarily illustrated in FIGS. 1A-1B and FIGS. 3A-3F. An insert member 101 is configured 2201 to conform to and be removably positioned on an inner surface 104 of a shoe 103 exemplarily illustrated in FIGS. 1A-1B, by one of: configuring 2201a the insert member 101 as a flat sheet having a substantially uniform thickness across an entire surface of the insert member 101 as exemplarily illustrated in FIG. 3A; configuring 2201b the insert member 101 to extend above the toes 106d and/or a heel 106b of a user's foot 106 shown in FIG. 1B, as exemplarily illustrated in FIGS. 3B-3D; configuring 2201c the insert member 101 to extend above an ankle 106c of a user's foot 106 exemplarily illustrated in FIG. 1B; configuring 2201d the insert member 101 to be positioned flat along a bottom surface 106a of the user's foot 106 exemplarily illustrated in FIG. 1B; configuring 2201e an entire periphery 101d of the insert member 101 to be extended above the foot 106 as exemplarily illustrated in FIG. 3E; configuring 2201f the insert member 101 to bend upwards to cover toes 106d of the foot 106 and extend upwards along sides of a midsection 106e and the heel 106b of the foot 106 shown in FIG. 1B and as exemplarily illustrated in FIG. 3F; configuring 2201g the insert member 101 as a bootie 901 or 1001 exemplarily illustrated in FIG. 9A and FIGS. 10A-10B respectively, to envelop an entire surface area of the foot 106; and configuring 2201h the insert member 101 as a three layered sheet, where a periphery of the three layered sheet is curved upwards to form an inwardly curved upper surface 101a and an outwardly curved lower surface 101b exemplarily illustrated in FIG. 2C. In the method disclosed herein, a non-slip material 102 is applied 2202 on the upper surface 101a and the lower surface 101b of the configured insert member 101 to provide simultaneous gripping contact between the upper surface 101a of the configured insert member 101 and the bottom surface 106a of the user's foot 106, and between the lower surface 101b of the configured insert member 101 and the inner surface 104 of the shoe 103.

The foregoing examples have been provided merely for the purpose of explanation and are in no way to be construed as limiting of the non-slip removable footwear insert 100 and the method disclosed herein. While the non-slip removable footwear insert 100 and the method have been described with reference to various embodiments, it is understood that the words, which have been used herein, are words of description and illustration, rather than words of limitation. Further, although the non-slip removable footwear insert 100 and the method have been described herein with reference to particular means, materials, and embodiments, the non-slip removable footwear insert 100 and the method are not intended to be limited to the particulars disclosed herein; rather, the non-slip removable footwear insert 100 and the method extend to all functionally equivalent structures, methods and uses, such as are within the scope of the appended claims. Those skilled in the art, having the benefit of the teachings of this specification, may effect numerous modifications thereto and changes may be made without departing from the scope and spirit of the non-slip removable footwear insert 100 and the method disclosed herein in their aspects.

I claim:

1. A non-slip removable footwear insert comprising:
an insert member configured to conform to and be removably positioned on an inner surface of footwear, the insert member comprising an upper surface and a lower surface, wherein the upper surface of the insert member is proximal to a user contact surface and distal to the inner surface of the footwear, and wherein the lower surface of the insert member is proximal to the inner surface of the footwear and distal to the user contact surface; and
a non-slip material applied on the upper surface and the lower surface of the insert member, the non-slip material configured to provide simultaneous gripping contact between the upper surface of the insert member and the user contact surface, and between the lower surface of the insert member and the inner surface of the footwear.

2. The non-slip removable footwear insert of claim 1, wherein the insert member is configured as a flat sheet having a substantially uniform thickness across an entire surface of the insert member.

3. The non-slip removable footwear insert of claim 1, wherein the insert member is configured to extend above one or more of toes and a heel of a foot of a user.

4. The non-slip removable footwear insert of claim 1, wherein the insert member is configured to extend above an ankle of a foot of a user.

5. The non-slip removable footwear insert of claim 1, wherein the insert member is configured to be positioned flat along a bottom surface of a foot of a user.

6. The non-slip removable footwear insert of claim 1, wherein an entire periphery of the insert member is configured to be extended above a foot of a user.

7. The non-slip removable footwear insert of claim 1, wherein the insert member is configured to bend upwards to cover toes of a foot of a user and extend upwards along sides of a midsection and a heel of the foot.

8. The non-slip removable footwear insert of claim 1, wherein the insert member is configured as a bootie to envelop an entire surface area of a foot of a user.

9. The non-slip removable footwear insert of claim 1, wherein the insert member is configured as a three layered sheet, wherein the three layered sheet is curved upwards to form an inwardly curved upper surface and an outwardly curved lower surface.

10. The non-slip removable footwear insert of claim 1, further comprising one or more ventilation openings configured on one or more selected positions of the insert member, wherein the one or more ventilation openings are configured to provide ventilation to a foot inserted into a cavity of the footwear and positioned on the non-slip removable footwear insert.

11. The non-slip removable footwear insert of claim 1, further comprising a connector assembly attached on the lower surface of the insert member and on the inner surface of the footwear, wherein the connector assembly is configured to fasten the non-slip removable footwear insert to the inner surface of the footwear.

12. The non-slip removable footwear insert of claim 1, further comprising a plurality of projections configured on the lower surface of the insert member for providing grip to the insert member over the inner surface of the footwear.

13. The non-slip removable footwear insert of claim 1, wherein the non-slip material applied on the upper surface of the insert member is one of similar to and dissimilar to the non-slip material applied on the lower surface of the insert member.

14. The non-slip removable footwear insert of claim 1, wherein the non-slip material is applied on one of an entire upper surface and a substantially entire upper surface of the insert member and on one of an entire lower surface and a substantially entire lower surface of the insert member.

15. The non-slip removable footwear insert of claim 1, wherein the non-slip material is applied on one of selective continuous portions, selective non-continuous portions, and whole portions of the upper surface and the lower surface of the insert member.

16. The non-slip removable footwear insert of claim 1, wherein the insert member is constructed by knitting non-slip threads with supplementary threads to define a non-slip upper surface and a non-slip lower surface for the insert member.

17. The non-slip removable footwear insert of claim 1, wherein the non-slip material is applied as one of a continuous strip and a non-continuous strip from a heel section to a toe section on one of the upper surface of the insert member and both of the upper surface and the lower surface of the insert member.

18. The non-slip removable footwear insert of claim 1, wherein the non-slip material is applied to one of selective continuous portions, selective non-continuous portions, and whole portions of the upper surface and the lower surface of the insert member by one or more of heat-gluing, pressure gluing, sewing, heat-sealing, heat pressing, spraying, pouring, painting, screen printing, and attaching the non-slip material to the one of the selective continuous portions, the selective non-continuous portions, and the whole portions of the upper surface and the lower surface of the insert member.

19. The non-slip removable footwear insert of claim 1, wherein the non-slip material is configured as a patch and attached to one of selective continuous portions and selective non-continuous portions of the upper surface and the lower surface of the insert member.

20. The non-slip removable footwear insert of claim 1, wherein the non-slip material is configured into one or more of multiple shapes and one of continuously applied and non-continuously applied on the upper surface and the lower surface of the insert member.
